(19) United States
(12) Patent Application Publication
(10) Pub. No.: US 2021/0279762 A1
(43) Pub. Date: Sep. 9, 2021

(54) METHOD AND APPARATUS FOR CONVERTING DATA FOR REWARD SYSTEMS

(71) Applicant: Resynct LLC, Brooklyn, NY (US)

(72) Inventor: Jonathan EKLUND, Brooklyn, NY (US)

(21) Appl. No.: 17/319,889

(22) Filed: May 13, 2021

Related U.S. Application Data
(63) Continuation-in-part of application No. 15/463,893, filed on Mar. 20, 2017.
(60) Provisional application No. 62/310,133, filed on Mar. 18, 2016.

(51) Int. Cl. G06Q 30/02

(52) U.S. Cl. CPC G06Q 30/0226; G06Q 30/0239

(57) ABSTRACT

An approach for providing points to a registered user for acquisition of a registered service. The approach involves a first system configured to implement first points at a first schema, wherein the first points are provided based on a determined usage of a first service. The approach also involves a second system configured to implement second points at a second schema, wherein the second points are provided based on a determined usage of a second service. The approach further involves an electronic interface configured to: receive a request from a user device to apply user points from the first system or the first service to the second system or the second service; transform the user points from the first schema to a fixed schema and then to the second schema; and transmit the user points transformed at the second schema via the electronic interface to the second system.

### RELATED APPLICATION

This application is a continuation-in-part of U.S. patent application Ser. No. 15/463,893, filed Mar. 20, 2017, entitled “Method and Apparatus for Providing a Hospitality Loyalty Platform,” which is a claims priority of U.S. Patent Application Ser. No. 62/310,133, filed Mar. 18, 2016, entitled “Method and Apparatus for Providing a Hospitality Loyalty Platform”; all of which are incorporated herein by reference in their entireties.

### BACKGROUND

Businesses (e.g., participating airlines, hotels, credit card companies, etc.) have used reward programs to create and maintain customer loyalty and increase the perceived value of their goods and services. For example, to increase consumer spending on goods or services, businesses often give their members, e.g., consumers, reward points as an incentive for recognition of their loyalty. However, implementing such reward programs needs to be efficient and seamless to the consumers, otherwise the perceived value of such reward programs is diminished. For instance, the conventional reward program system is technologically complex and burdensome to implement and has numerous limitations: (i) redemption process through a ticketing agency or an exchange is inefficient, time-consuming, and burdensome for consumers, (ii) a requirement that consumers meet the minimum threshold requirement before redeeming the reward points is highly inconvenient, (iii) restrictions on redeeming reward points between different service providers, (iv) lengthy reward redemption mechanism, and/or (v) multiple systems belonging to different entities, e.g., hotels, consumers, booking engine providers, etc., typically must interoperate to provide for earning and redeeming loyalty points or other loyalty incentives, thereby resulting in disappointing delivery of rewards to customers.

Therefore, there is a need for an approach for providing a universal and customizable implementation of reward programs by different hospitality entities.

### SOME EXAMPLE EMBODIMENTS

According to one embodiment, a system comprises a first system configured to implement one or more first points at a first schema, wherein the one or more first points are provided based on a determined usage of a first service associated with the first system. The system also comprises a second system configured to implement one or more second points at a second schema, wherein the one or more second points are provided based on a determined usage of a second service associated with the second system. The system further comprises an electronic interface configured to: receive a request from a user device to apply one or more user points from the first system or the first service to the second system or the second service; transform the one or more user points from the first schema to a fixed schema and then from the fixed schema to the second schema; and transmit the one or more user points transformed at the second schema via the electronic interface to the second system.

According to another embodiment, a method comprises providing an electronic interface between a first system with one or more points implemented at a first schema and a second system with one or more other points implemented at a second schema, wherein the one or more points are provided based on a determined usage of a first service associated with the first system, and wherein the one or more other points are provided based on a determined usage of a second service associated with the second system. The method also comprises receiving a request from a user device to apply one or more user points from the first system or the first service to the second system or the second service. The method further comprises transforming the one or more user points from the first schema to a fixed schema and then from the fixed schema to the second schema. The method also comprises transmitting the one or more transformed user points via the electronic interface to the second system.

According to another embodiment, a non-transitory computer-readable storage medium carries one or more sequences of one or more instructions which, when executed by one or more processors, cause, at least in part, an apparatus to provide an electronic interface between a first system with one or more points implemented at a first schema and a second system with one or more other points implemented at a second schema, wherein the one or more points are provided based on a determined usage of a first service associated with the first system, and wherein the one or more other points are provided based on a determined usage of a second service associated with the second system. The apparatus is also caused to receive a request from a user device to apply one or more user points from the first system or the first service to the second system or the second service. The apparatus is further caused to transform the one or more user points from the first schema to a fixed schema and then from the fixed schema to the second schema. The apparatus is also caused to transmit the one or more transformed user points via the electronic interface to the second system.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the originally filed claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing points to at least one registered user for acquisition of a registered service, wherein payment may be partially made through automated redemption of the points from at least one point account, according to one example embodiment;

FIG. 2A is a diagram of the components of the channel manager platform 109, according to one example embodiment;

FIG. 2B is a flowchart of a process for transferring points between one or more systems for acquisition of a registered service, according to one embodiment;

FIG. 2C is a flowchart of a process for retrieving a contract between different reward systems from a blockchain, according to one embodiment;

FIG. 2D is a flowchart of a process for redemption of the transformed user points, according to one embodiment;

FIG. 2E is a flowchart of a process for recommending a service to a registered user, according to one embodiment;

FIG. 2F is a flowchart of a process for determining that the user points from one schema is sufficient for another schema, according to one embodiment;

FIG. 2G is a flowchart of a process for updating the user points, according to one embodiment;

FIG. 3 is a flowchart of a process for providing points to a registered user for acquisition of a registered service, and exchanging the points as a partial payment for the registered service, according to one embodiment;

FIG. 4 is a flowchart of a process for calculating points for a registered user, and depositing the points in a point account associated with the registered user, according to one embodiment;

FIG. 5 is a flowchart of a process for selling one or more points by the participating service providers, according to one embodiment;

FIG. 6 is a flowchart of a process for storing reservation information, and updating status information, according to one embodiment;

FIG. 7 is a flowchart of a process for monitoring exchange rate of currencies associated with participating service provider and the user, according to one embodiment;

FIG. 8 is a diagram that represents a registration workflow, according to various embodiments;

FIG. 9 is a diagram utilized in the processes of earning points for at least one registered user, according to various embodiments;

FIG. 10 is a diagram utilized in the processes of redeeming points for at least one registered user, according to various embodiments;

FIG. 11 is a flowchart of a process that depicts the reservation life cycle, according to one example embodiment;

FIGS. 12A-12D illustrate diagrams of a user interface for user registration and making reservations, according to various example embodiments;

FIGS. 12E-12G are user interface diagrams that illustrate the redemption process of reward points, according to various example embodiments;

FIG. 13 is a diagram of hardware that can be used to implement an embodiment of the invention;

FIG. 14 is a diagram of a chip set that can be used to implement an embodiment of the invention; and

FIG. 15 is a diagram of a mobile terminal (e.g., handset) that can be used to implement an embodiment of the invention.

### DESCRIPTION OF SOME EMBODIMENTS

Examples of a method, apparatus, and computer program for providing points to at least one registered user for acquisition of a registered service, wherein payment may be partially made through automated redemption of the points from at least one point account are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

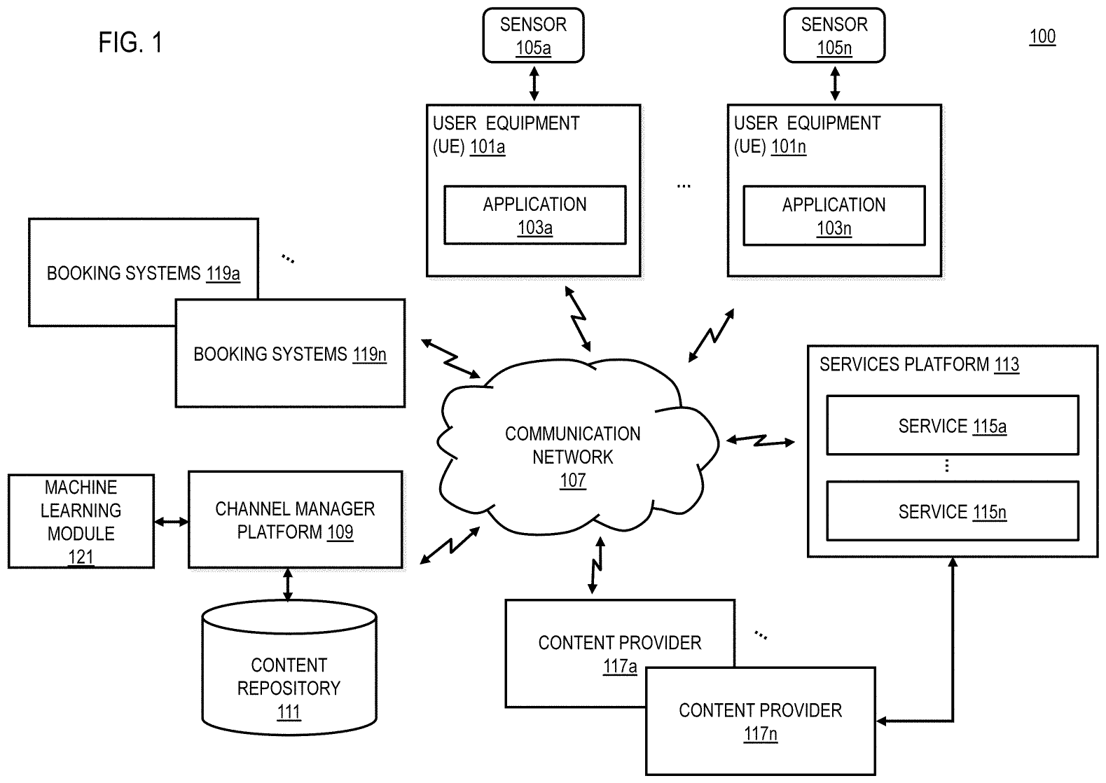

FIG. 1 is a diagram of a system capable of providing points (i.e., loyalty points, reward points, etc.) to at least one registered user for acquisition of a registered service, wherein payment may be partially made through automated redemption of the points from at least one point account, according to one embodiment. Loyalty/reward programs are implemented to retain existing customers, attract new customers, and increase the use of a service by the existing customers. For example, loyalty programs encourage loyal buying behavior by providing rebates, discounts, reward points, and other incentives to users who make frequent purchases at the associated business. In a loyalty/reward program a customer earns points for undertaking certain activities (e.g., purchasing certain services), and these points may be redeemed by the members while purchasing any future services. However, conventional reward programs struggle to remain relevant to their members because the awards are not tailored to their preferences. There has been a decline in the participation of customers in traditional rewards programs due to multiple challenges. Failure to meet a member's expectations can result in a member signing up and then quickly dropping out of the program due to lack of interest. Furthermore, these reward programs are not easily accessible, and require multiple steps on the consumer to participate.

The conventional redemption process through a ticketing agency or on an exchange is time-consuming and annoying for the consumer. For example, members of the reward programs may obtain a discount or redeem their reward points through a ticketing agency. The members may visit a ticketing agency's website/application, and select event tickets for purchase. As loyalty points are offered as a payment option, the members may choose to use loyalty points to pay for purchases. Such selection may be made from a drop-down menu of payment choices, checkboxes, radial buttons, and/or the like. In addition to selecting the payment option, the members need to input a particular amount of loyalty points that may be debited from their account to complete the purchase. However, users want to be able to redeem points in real-time, hence a system is needed to facilitate the redemption of reward points in real-time.

Furthermore, members of the reward programs are not allowed to redeem a small number of points, which is highly inconvenient. For example, the reward programs may require their members to earn a minimum of 10,000 points before they can redeem or exchange them. This is cumbersome to the members because they cannot redeem the reward points per their need, and it may take them a long time to accumulate 10,000 points if they earn 2 reward points for every dollar spent.

Loyalty/reward programs typically include individual member loyalty point accounts which record the balance of reward points earned by the individual member. The individual member may desire to share or transfer the reward points to other members. The individual member may also know a friend who has excess reward points that they wish to transfer to the individual member in need of additional reward points. Moreover, the individual member may immediately need additional reward points in his or her loyalty account to have a sufficient number of reward points for a certain award. However, existing loyalty/reward programs do not allow efficient transfer of reward points between members. Moreover, while some loyalty accounts may allow the members to use their loyalty points to purchase gifts for others, the loyalty points are not transferable to other members so that they can aggregate points to purchase a gift of their choice, e.g., users cannot redeem their points obtained from a particular hotel in other hotels.

Furthermore, the services and associated systems for reward programs generally utilize incompatible data sets, hence real-time data from the services and associated systems is difficult within the existing reward programs framework. This lack of real-time data integration across the services and associated systems affects data integrity, e.g., incompatible data sets hold conflicting data because one data was updated while another data was not. As a result, data can become untrustworthy as different versions of the same data are stored. Such incompatibility in data may also result in poor data quality, data gaps, missing documentation, etc. Furthermore, consumers do not have access to services, e.g., analysis tools, that handle incompatible data sets and perform the necessary correlations.

To address these problems, system 100 of FIG. 1 introduces the capability for registered members to make payment for registered services through an automated redemption of the reward points from their respective reward points account. System 100 also enables users to redeem a small amount of points amongst one or more participating hotels in real-time, thereby enabling flexibility in using reward points within a collaborative marketplace without restrictions. In one example embodiment, system 100 implements artificial intelligence (AI), machine learning, and blockchain technology to locate the members' accounts and then automatically credit them with reward points based on real-time transactions. Furthermore, system 100 correlates incompatible data sets in real-time, thereby providing a foundation for direct and seamless data interoperability among various data systems.

As shown in FIG. 1, the system 100 comprises of UE 101. In one embodiment, the UE 101 may include, but is not restricted to, any type of a mobile terminal, wireless terminal, fixed terminal, or portable terminal. Examples of the UE 101, may include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In addition, the UE 101 may facilitate various input means for receiving and generating information, including, but not restricted to, a touch screen capability, a keyboard and keypad data entry, a voice-based input mechanism, and the like. Any known and future implementations of the UE 101 may also be applicable.

The UE 101 may further include applications 103. Further, the applications 103 may include various applications such as, but not restricted to, content provisioning application, social networking application, calendar applications, multimedia application, camera/imaging application, media player application, location-based service application, and the like. In one embodiment, the applications 103 are installed within the UE 101.

The system 100 also includes one or more sensors 105, which can be implemented, embedded or connected to the UE 101. The sensors 105 may be any type of sensor. In certain embodiments, the sensors 105 may include, for example, but not restricted to, a global positioning sensor (GPS) for gathering location data, a network detection sensor for detecting wireless signals or receivers for different short-range communications (e.g., Bluetooth, Wi-Fi, Li-Fi, Near Field Communication (NFC) etc.), temporal information sensors (e.g., additional discount defined by a hotel for specific dates), a camera/imaging sensor for gathering image data, and the like. In one example embodiment, the GPS installed in the UE 101 enables the channel manager platform 109 to determine, for example, position, destination, heading, context, for at least one UE 101. Then, the channel manager platform 109 may filter hotel information and offers based on location information for at least one user of the UE 101.

Further, various elements of the system 100 may communicate with each other through a communication network 107. The communication network 107 may support a variety of different communication protocols and communication techniques. In one embodiment, the communication network 107 allows booking system 119 to communicate with UE 101 associated with the members. The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular communication network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), vehicle controller area network (CAN bus), and the like, or any combination thereof.

In one embodiment, the channel manager platform 109 may be a platform with multiple interconnected components. The channel manager platform 109 may include one or more servers, intelligent networking devices, computing devices, components and corresponding software for providing points to at least one registered user for acquisition of a registered service, wherein payment may be partially made through automated redemption of the points from at least one point account. In addition, it is noted that the channel manager platform 109 may be a separate entity of the system 100, a part of the one or more services 115a-115n (collectively referred to as services 115) of the services platform 113, or the UE 101.

In one embodiment, the channel manager platform 109 may manage a loyalty program for registered users booking a service with one of the participating hotels. In another embodiment, the channel manager platform 109 may provide a cross-reservation management of the one or more participating hotels amongst their registered users. In one example embodiment, the channel manager platform 109 may consist of a responsive website to explain registered users and/or potential users on the loyalty/rewards programs, and the hotels on the cross-reservation management. There can also be a responsive backend for service users (e.g., hotel users), registered members, etc. In one scenario, the website is completely mobile responsive (e.g., optimized for UE 101's). In another scenario, the homepage of the website provides detailed explanation of the service being rendered. In a further scenario, the homepage includes: (a) login features, (b) a simple registration form, (c) a frequently asked questions pages, (d) terms and conditions, and (e) contact information. In one example embodiment, one or more hotels may click the “contact us” tab in the website to ask for hotel membership. The backend components of the website for hotels can include: (a) a contracting section, (b) a section on reservation history, (c) a section on hotel point transaction history, (d) a section on accounting and (e) an ability to confirm reservations section. In one scenario, a hotel while doing the set-up may automatically receive the terms and conditions in real-time so the hotel can get immediate access to the hotel manager backend portal and start using the system. In another example embodiment, a member (e.g., a customer) may fill a short registration form available in the website as a part of the login widget. The backend components of the website for customers can include: (a) a point account balance section, (b) a profile management section, (c) a section to change password, (d) a section to upload photos, (e) a reservation history section, (f) a history of point transaction section, (g) a contact and feedback features, (h) a location based hotel browser and best offers features, etc. In one scenario, a customer while setting-up an account may automatically receive the terms and conditions in real time and can get immediate access to the system. In a further example embodiment, the website may include one or more sections for their administrative staff. The section may comprise of: (a) a hotels management section, (b) a reservation history with filters section, (c) members listing and management section, (d) accounting section, and (e) reporting section.

In one embodiment, the channel manager platform 109 provides a cross-reservation management to the participating hotels by providing loyalty points or reward points to their customers. In one embodiment, the channel manager platform 109 updates data records to indicate loyalty points or reward points for a customer of at least one participating hotel. Then, the loyalty points or reward points are transferred to the point account associated with the customer. The channel manager platform 109 maintains a close association with the participating hotels, customers and the booking engine to update status information in real-time.

In one embodiment, the channel manager platform 109 may store every reservation in its system immediately after a reservation has been successfully placed. The channel manager platform 109 may track two different flags (with potential values listed):
Hotel status: {new, valid, invalid}
Client status: {new, confirmed, disputed}

The channel manager platform 109 may set “new” as the default value for both flags. The manager of the participating hotels are responsible for maintaining the hotel status and the clients are responsible for maintaining the client status (e.g., manage his/her profile, etc.). In another embodiment, the channel manager platform 109 may setup a minimum usable amount of points for members and may also setup a buy-back minimum for hotels.

In one embodiment, the channel manager platform 109 calculates points for one or more members. In one embodiment, there are few constants playing role in the point system, as follows:
100 points=$1
Commission to points ratio=50% (part of commission which goes to the customer in form of points)
Point payment minimum=500 (when paying with points, the number of points used must be higher or equal to 500).
Discounted booking default point value: 100 points=$3 (this can be changed by hotel manager in discount definition section).

In one example embodiment, user A is an authenticated member of the hotel booking service and he is going to make a booking via the booking engine of the channel manager platform 109. He has collected 30,000 points on his point account. The reservation amount is $200 and he is going to pay 10,000 points to get a lower price. The hotel booking service of the channel manager platform 109 has a 15% commission negotiated with the hotel.
Amount paid by points A (discount)=10000/100=$100
New (discounted) total for the reservation=$200−$100=$100
Service providers commission=$100*15%=$15
Points earned by user A=$15*50%*100=750 points
Payment for a hotel=$100+10000 points.

In another example embodiment, user B is an authenticated member of the hotel booking service and she is going to make a booking via the booking engine of the channel manager platform 109. She has 30, 000 points collected on her point account. The reservation amount is $200, and hotel booking service of the channel manager platform 109 has a 15% commission negotiated with the hotel. In this example following details about the reservation are known:

| Date | 2015 Oct. 22 | 2015 Oct. 23 | 2015 Oct. 24 |
|---|---|---|---|
| Amount | $60 | $60 | $60 |
| Custom Discount | 10% | 10% | 0 |
| (defined by hotel in the | | | |
| backend) | | | |

In the above example, the maximum custom discount available for the reservation=$6+$6+0=$12. The amount of points needed to get whole custom discount=$12/($3−$1)*100=600 points. The increased value of 100 points is $3 (by default) and normal amount of 100 points is $1 USD. It means that custom discount is distributed as $2 extra per each 100 points (applies to first 600 points only in this example).

In one scenario, if user B spends 600 points then the channel manager platform 109 performs the following calculations:
Points spent=600
Discount=600*$3/100=$18
Value of points for a hotel=600*$1/100=$6
Discount provided by hotel (hotel expense)=$18−$6=$12.

In another scenario, if user B spends 1000 points then the channel manager platform 109 performs the following calculations:
Points spent=1000
Discount=600*$3/100+400*$1/100=$18+$4=$22
Value of points for a hotel=1000*$1/100=$10
Discount provided by hotel (hotel expense)=$22−$10=$12.

In one example embodiment, Hotel A is located in Czech Republic and its base currency is CZK. If the amount of booking is 6,000 CZK, and the user A is going to pay half of that with his points, the channel manager platform 109 performs the following calculations:
Booking time exchange rate: $1=25 CZK
Price in US Dollar=6000 CZK/25=$240
Amount paid by points=$120=12,000 points=3000 CZK
Amount paid by Credit Card=3000 CZK
Hotel is going to collect: 3000 CZK+12,000 points.

In one scenario, hotel A decides to sell the points a month later to the hotel booking services. At that point, the channel manager platform 109 performs the following calculations:
Current exchange rate: $1=22 CZK
Amount of points to be sold=12,000 pts=$120
Amount in CZK=2640 CZK
Lost for a hotel=3000 CZK−2640 CZK=360 CZK
Percentage lost=360/3000=12%.

As shown in the above example, there is a currency exchange related risk for a hotel. If the commission was 12% then the loss would be eliminated, and the service provider only collects commission for that part of a reservation which is paid directly by money. If the commission was less than 12% (which is more likely) there would be a loss on hotel side. However, if the exchange rate is switched in the example then hotel gets 409 CZK more. Since currency rates are frequently changing, the channel manager platform 109 constantly monitors the exchange rate fluctuations and may alert the required parties.

The rise in the rewards program and big data has resulted in an upsurge in consumer information. In one embodiment, the channel manager platform 109 may ingest consumer information, e.g., historical purchase information, past online activities, etc., stored in content repository 111 for processing by a machine learning module 121 to predict future purchases of the consumer. The machine learning module 121 may use predictive analytics to process structured and unstructured consumer information stored in content repository 111 to optimize the predictive power. Predictive analytics integrates various techniques from data mining, statistics, modeling, machine learning, and artificial intelligence to process and analyze various data sets for the purpose of developing predictions. Thereafter, machine learning module 121 may customize rewards points based on the prediction and present relevant offers to the consumers. For example, when a member is getting started, machine learning module 121 analyzes past purchase data to recommend a “perfect-fit” rewards program structure for the member. The program structure may be completely different for each member, thereby resulting in each member starting with a precisely optimized rewards program. In another embodiment, machine learning module 121 may predict the risk of fraud and/or identify potentially fraudulent redemptions. In one example embodiment, the machine learning module 121, in real-time, monitors members' behavior, historical point transactions, or redemption history. Thereafter, machine learning module 121 with predictive fraud modeling scores the likelihood of fraud, while detecting anomalies, auditing, logging incidents, and flag inconsistencies.

In one embodiment, the content repository 111 may store and manage any multiple types of information that can provide means for aiding in the content provisioning and sharing process. In one example embodiment, the content repository 111 may, for instance, be utilized to access and/or store user information, such as user identifiers, passwords, device information associated with users, payment resource information associated with users, such as credit cards, debit cards, banks, points, etc. In another example embodiment, the content repository 111 may, for instance be utilized to access and/or store information regarding services, offers (e.g., discounts), merchant-specific loyalty/rewards programs, etc. The information stored within the content repository 111 may also be categorized or otherwise indexed with respect to geographic regions such that, for example, specific offers may be provided with respect to specific geographic regions. In one embodiment, the content repository 111 stores reward earned by the users, and any restrictions on the redemption of those rewards, allowing the member easy access to the information. In one example embodiment, each time a member earns (or is issued) a reward point, the reward information is processed by the channel manager platform 109. Platform 109 then sends the data, e.g., users' identification number, identification information of the member partner who issued the reward, nature and amount of the reward, and any limitations on the redemption of the rewards (e.g., expiration of the particular reward), to content repository 111. In another embodiment, content repository 111 may be any type of database, such as relational, hierarchical, object-oriented, and/or the like. Content repository 111 may be organized in any suitable manner, including as data tables or lookup tables.

The services platform 113 may include any type of services. By way of example, the services platform 113 may include travel planning services/application, social networking services/application, content (e.g., audio, video, images, etc.) provisioning services/application, application services/application, storage services/application, contextual information determination services/application, location based services/application, etc. In one embodiment, the services platform 113 may interact with the UE 101, the channel manager platform 109 and the content provider 117 to supplement or aid in the processing of the content information. In one embodiment, the services platform 113 may be implemented or embedded in the channel manager platform 109 or in its functions. In one example embodiment, services platform 113 allows channel manager platform 109 access to user account information from social networks and to retrieve social network activity data from the social networks.

By way of example, the services 115 may be an online service that reflects interests and/or activities of users. The services 115 allow users to share contact information, location information, user profile information, activity information, contextual information, historical user information and interests within their individual networks, and provides for data portability. In one example embodiment, the services 115 may assist in providing the channel manager platform 109 with information on travel plans of the at least one user, history of hotel reservations for the at least one user, history of point transactions for the at least one user, and a variety of additional information.

In one embodiment, the booking systems 119 is used by the participating hotels to manage their inventory, rates, occupancy, etc. In another embodiment, the booking systems 119 is an automated system that tracks bookings or reservations of their resources (e.g., rooms) to gather real time knowledge of occupancy or utilization rates. In such manner, the booking systems 119 maintains reservation information, availability information, cost information, data records, or a combination thereof for one or more rooms of one or more participating hotels. In a further embodiment, the booking systems 119 interfaces directly with the channel manager platform 109 and/or the consumer requests received from online and/or client applications.

In one embodiment, the booking systems 119 stores a data table that provides exchange rates for converting points earned at one hotel to points or payment amounts for another hotel. In another embodiment, the booking systems 119 stores constants that are fundamental in calculating the point system, for example, (a) 100 points totals $1, (b) 500 points as the minimum points required to make payments, (c) 50% as a commission to the customer in the form of points for a confirmed reservation, (d) discounted default values, etc. In a further embodiment, the booking systems 119 stores commission information negotiated with the participating hotels. In one scenario, the channel manager platform 109 provides higher points to a user for booking a room in a hotel that provides higher commission amount to the service provider.

By way of example, the UE 101, the channel manager platform 109 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

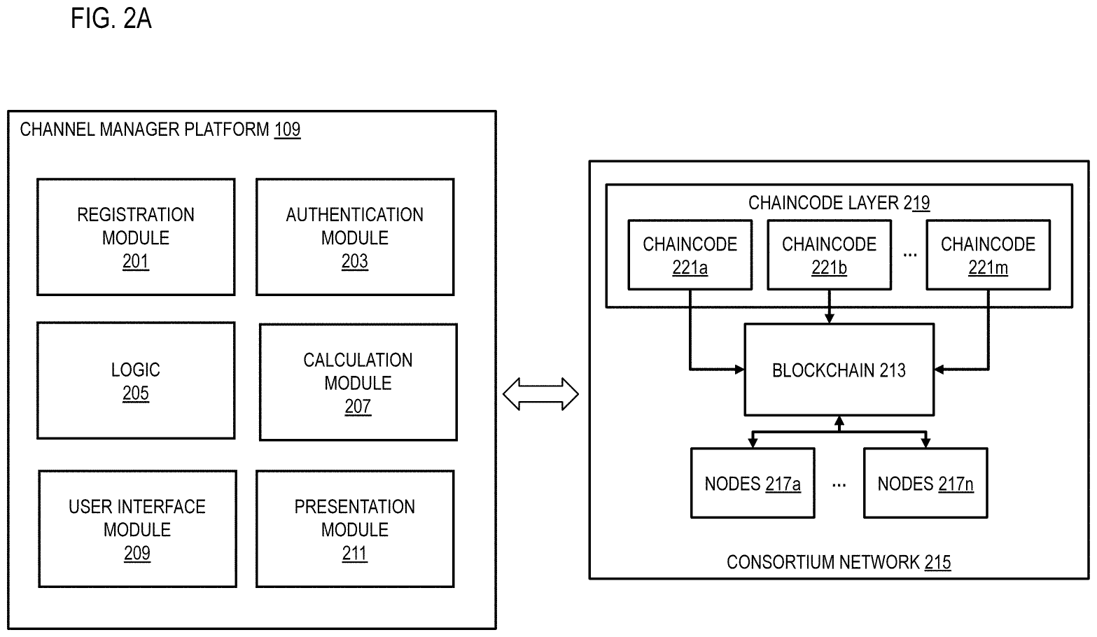

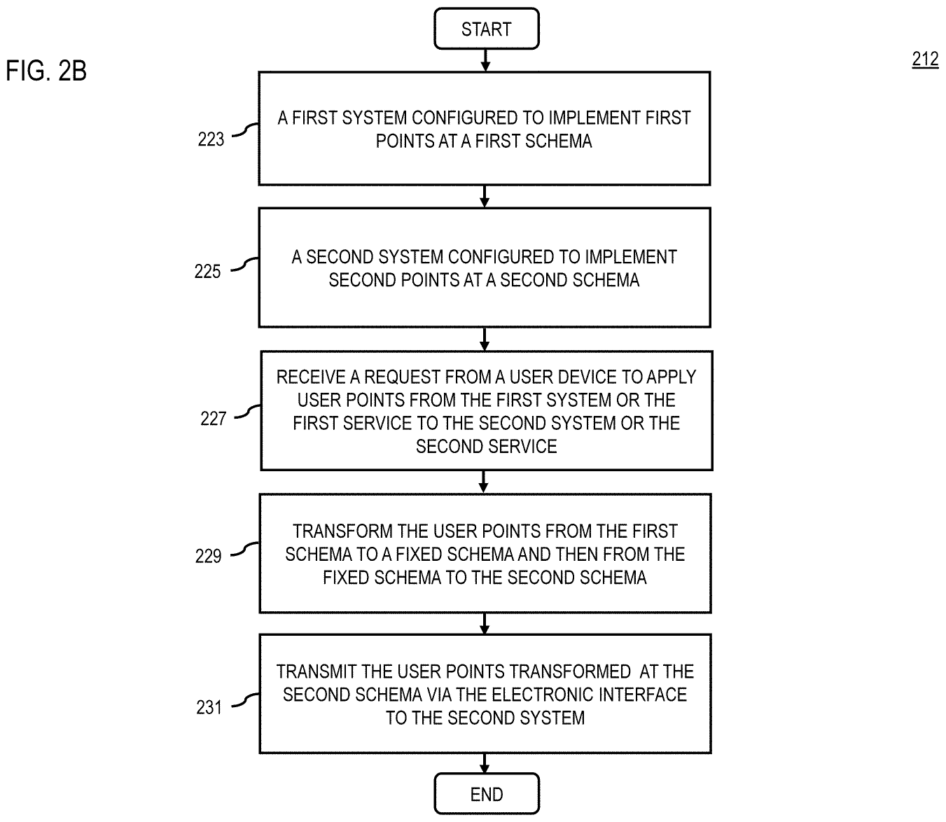

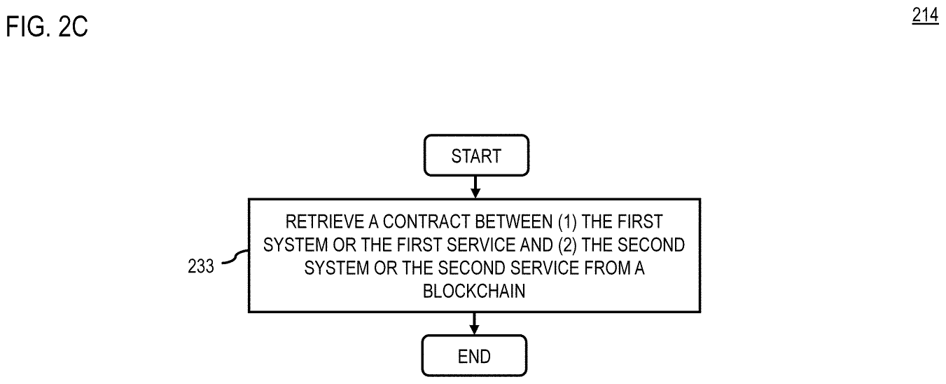

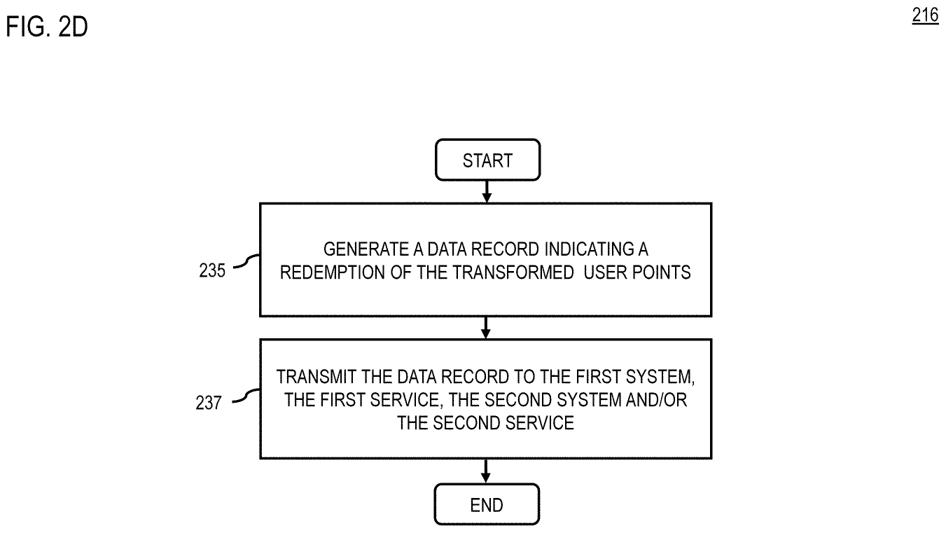

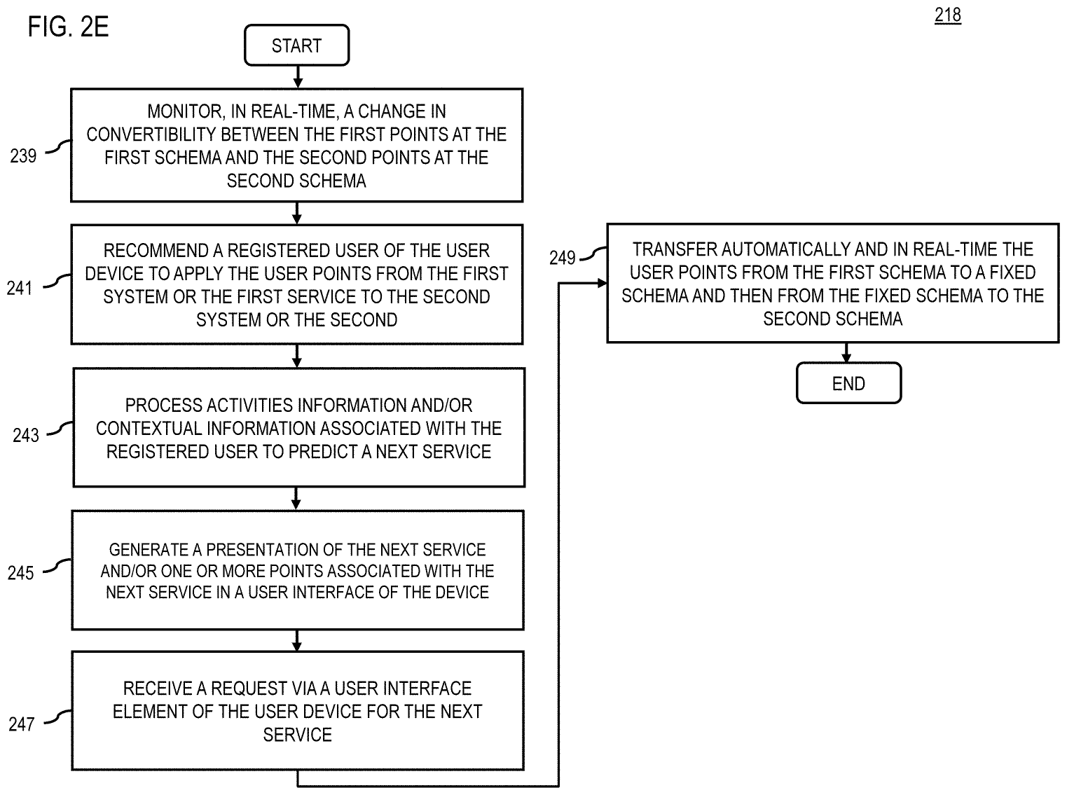

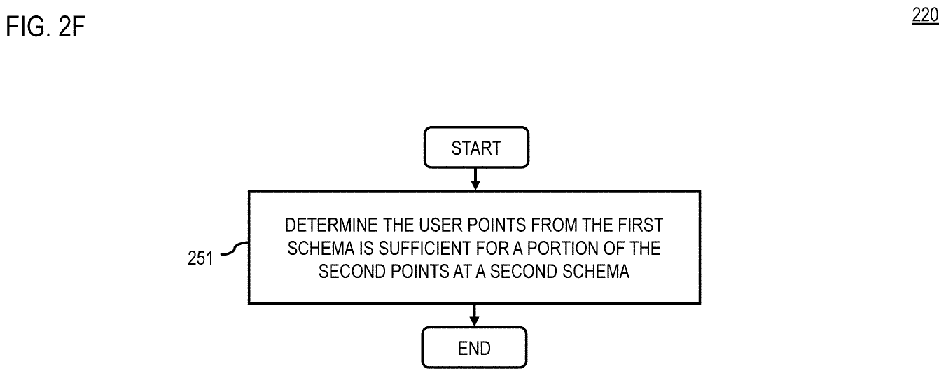

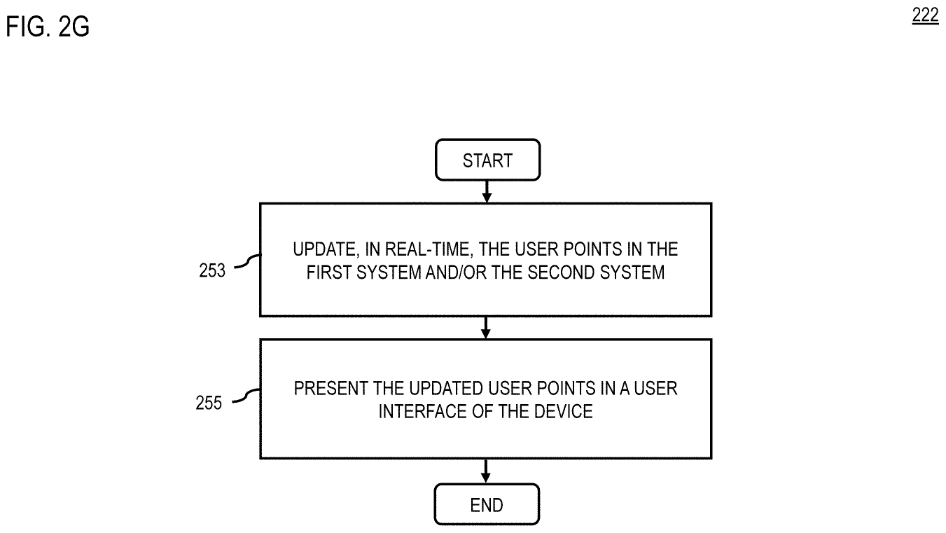

FIG. 2A is a diagram of the components of the channel manager platform 109, according to one example embodiment. By way of example, the channel manager platform 109 includes one or more components for providing points to at least one registered user for acquisition of a registered service, wherein payment may be partially made through automated redemption of the points from at least one point account. It is contemplated that the functions of these components may be combined in one or more components or performed by other components of equivalent functionality. In one embodiment, the channel manager platform 109 comprises one or more registration modules 201, authentication modules 203, logic 205, calculation modules 207, user interface modules 209, presentation modules 211, a communication module, or any combination thereof.

In one embodiment, the registration module 201 may register at least one user of at least one UE 101, actual communication identifiers associated with at least one UE 101, or a combination thereof. In one scenario, the actual communication identifiers include email address, phone number, social media information, or a combination thereof associated with at least one user of the at least one UE 101. In another embodiment, the registration process may be performed through automated association of profile settings maintained with an IP address, a carrier detection signal of a user device, mobile directory number (MDN), subscriber identity module (SIM), radio frequency identifier (RFID) tag or other identifier. Once registered, the registration module 201 conveniently creates a profile for each registered user, wherein each profile is associated with at least one reward account. In one embodiment, the registration module 201 comprises one or more apparatuses and databases, e.g., content repository 11, for creating or maintaining a record of each member and enables associating the databases with the members. In an example of registration module 201, a business entity, e.g., a shopping center, a restaurant, or a hotel, can each form and enroll in booking system 119, and can each enroll members associated with their respective booking system 119. In another embodiment, the registration module 201 is configured to receive updated particulars associated with one or more participating members (e.g., member business entities, registered users, etc.) to update an existing reward account. The registration module 201 is configured to transmit a suitable message, e.g., via e-mail, to the registered users to confirm registration or profile updates. The registration module 201 may interface with content repository 111 to store user profiles and access various types of information about users, accounts, account settings, etc.

In one embodiment, UE 101 which desires to connect to, for example, the services provided by the channel manager platform 109, first authenticates itself against the authentication module 203 through the communication network 107. In one scenario, the UE 101 transmits its credentials to the authentication module 203 to be used for authentication purposes. In one example embodiment, the credentials of the UE 101 can include username and password. However, it is contemplated that any credentials can be used for authentication purposes, such as biometrics, one time password, network address filtering, etc. The authentication module 203 examines and validates the received credentials of the UE 101 to a record in the content repository 111. The authentication module 203 may search the content repository 111 to identify any information associated with a user. In addition, the authentication module 203 receives secondary information including, but not limited to, the internet protocol (IP) address of UE 101 from which the login request is originating, the device identification number of UE 101 being used to request a login, the location of the UE 101 from which the login request is originating, and/or verified browser cookies. In one embodiment, the authentication module 203 can include a single sign-on authentication process that enables a user (e.g., a user device, a client application, user of a user device, etc.) to authenticate once and gain access to resources of multiple software, applications, servers, etc., without being prompted to authenticate itself again at each of the resources. In another embodiment, the credentials may be received as encrypted ciphertext and then decrypted according to any security protocols. The credentials may be processed to decipher or decrypt before authenticating the user. The credentials may be associated with an established user identity stored in content repository 111. If the user credentials match an established user identity stored in the content repository 111, the user may be provided access to the service. In one embodiment, the authentication module may also limit the number of times a user may try to authenticate into the booking system. If the user cannot authenticate, or if the user exceeds the number of attempts permitted to authenticate, the authentication module 203 denies access. In other instances, the authentication module 203 is used in account recovery when the user has forgotten his/her username and/or password. In some instances, the authentication module 203 detects a potentially fraudulent authentication by analyzing the secondary information included in the login request. For example, if the IP address associated with the login request is an IP address of a “blacklisted” user, or a suspected bot, the user authentication module 203 identifies the login request as potentially fraudulent. The authentication module 203 detects a potentially fraudulent authentication by comparing the secondary information to historical authentication information of the account owner. For example, if the login request for authentication originates from a country, or device, that the requesting user has not attempted to send login requests from before, the authentication module 203 identifies the login request as potentially fraudulent. In some instances, a potentially fraudulent authentication attempt includes a failed authentication attempt.

In one embodiment, the logic module 205 may manage tasks, including tasks performed by the other modules. Logic module 205 may be implemented to provide logic, control, coordination, command, signaling, and other functions and features for channel manager platform 109. For example, although the other modules may perform their actual tasks, the logic module 205 may determine when and how those tasks are performed or otherwise direct the other modules to perform the task. In one example embodiment, the logic module 205 may selectively route communications to at least one registered UE 101 based on device capability information, resource availability information, user configuration, or a combination thereof.

The calculation module 207 can be configured to calculate fees to be charged or points to be allocated. In one embodiment, the calculation module 207 may collect flat or relative commission for every reservation made by the registered members in the participating hotels. Then, the calculation module 207 may convert a fixed percentage (i.e., the percentage is same across all the hotels) of this commission into points. Subsequently, these converted points are deposited to the at least one member's point account based, at least in part, on a validation that the actual stay has been confirmed by the member. In one example embodiment, the at least one member may use these points to get a discount on later bookings in any participating hotel whereupon the channel manager platform 109 may transfer the points to the participating hotel's point account. Then, the participating hotels can sell these points to collect money from the channel manager platform 109. In another embodiment, the calculation module 207 may deposit the remainder of the commission as a profit. In a further embodiment, the calculation module 207 may determine a fixed internal value of the points for the participating hotels and the members, for example, $1 equals to 100 points. This can also be a default value of the points for the customers across all hotels. In one embodiment, the calculation module 207 may internally process transactions is US dollars or in points (whichever is equivalent) irrelevant to the location of the hotel or the currency of the customer. In another example embodiment, one or more participating hotels may define additional percentage discounts (custom discounts) per given dates and room types. Then, the calculation module 207 may incorporate the increased value of the points to get the additional percentage discount in the participating hotels. In one example embodiment, the machine learning module 121 may scan large amounts of data, e.g., past transactions, pricing of competitors, contextual data, etc., and analyze different pricing scenarios to provide pricing recommendations to calculation module 207.

In certain embodiments, the calculation Module 207 is constantly receiving data from participating businesses. In these embodiments, the calculation Module 207 dynamically sets a value for reward points, hence the value of reward points is constantly changing. In one example embodiment, the calculation module 207 may set higher reward points for doing a transaction with a particular business to increase sales or demands for that particular business. Alternatively, on traditional high shopping volume days, e.g., Black Friday, the calculation module 207 may set a low value for reward points for participating businesses. In another embodiment, calculation Module 207 may base the valuation of reward points upon customer trends. For instance, if customer demand for a specific good/service in a particular geographical area is traditionally high, then calculation Module 207 tends to assign a relatively low value of reward points to a customer in conjunction with the purchase of that specific good/service. Alternatively, if customer demand in a certain geographical area is traditionally low for a specific good/service, then calculation Module 207 tends to assign a relatively high value of reward points to a customer in conjunction with the purchase of that specific good/service.

In one embodiment, the user interface module 209 enables presentation of a graphical user interface (GUI) in at least one UE 101. The user interface module 209 employs various application programming interfaces (APIs) or other function calls corresponding to the applications 103 of UE 101, thus enabling the display of graphics primitives such as icons, menus, buttons, data entry fields, etc., for generating the user interface elements. In a further embodiment, the user interface module 209 may cause an interfacing of the guidance information with one or more users to include, at least in part, the one or more annotations, audio messages, or a combination thereof. In one example embodiment, the user interface module 209 may display banners (i.e., images with some advertisement content) in at least one UE 101 or at least one website. These banners may promote the services being rendered, and may redirect users to the registration page for the services being rendered. The user interface module 209 may present different banners linking to different registration pages based on the types of members (e.g., the participating hotels, the registered members, the potential members, etc.). In another example embodiment, the user interface module 209 may display a login widget in at least one UE 101 or a website (e.g., websites of the participating hotels or any websites rendering hotel booking services). The user interface module 209 ensures that the login widget is distinctive to be recognized by the users (e.g., members, visitors) and unobtrusive to avoid any negative user experiences while visiting the website. In addition, the login widget icon may also have a share function (linked to various social networking websites) and a registration function. In a further example embodiment, the user interface module 209 displays a booking widget in at least one UE 101 and/or at least one website rendering hotel booking services. The booking widget is visible only to the logged-in customers. The purpose of this UI element is to give information to the user regarding the rewards available and to use points in order to get a discount or perks.

In one embodiment, the presentation module 211 obtains a set of summary statistics and/or updates from the other modules. The presentation module 211 may present at least one user interface in at least one UE 101 and/or at least one website that allows the user to select at least one service (e.g., book a hotel). In one scenario, the presentation module 211 may generate a presentation of at least one notification in one or more UE 101 and/or at least one website requesting for access credentials. In another scenario, the presentation module 211 may cause a presentation of notification regarding granting, rejection, pending, or a combination thereof of access requests.

The above presented modules and components of the channel manager platform 109 can be implemented in hardware, firmware, software, or a combination thereof. Though depicted as a separate entity in FIG. 1, it is contemplated that the channel manager platform 109 may be implemented for direct operation by respective UE 101. As such, the channel manager platform 109 may generate direct signal inputs by way of the operating system of the UE 101 for interacting with the applications 103. In another embodiment, one or more of the modules 201-211 may be implemented for operation by respective UEs, as the channel manager platform 109, or combination thereof. Still further, the channel manager platform 109 may be integrated for direct operation with the services 115, such as in the form of a widget or applet, in accordance with an information and/or subscriber sharing arrangement. The various executions presented herein contemplate any and all arrangements and models.

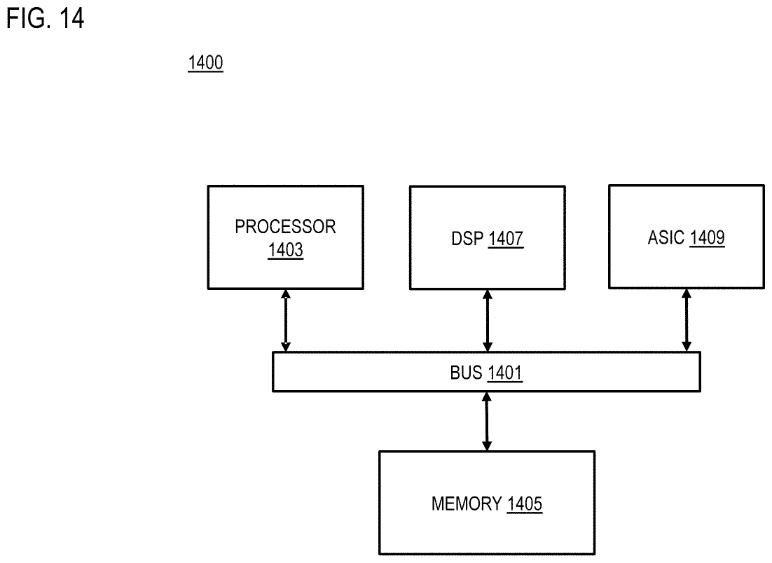

FIG. 2B is a flowchart of a process for transferring points between one or more systems for acquisition of a registered service, according to one embodiment. In one embodiment, the channel manager platform 109 performs the process 212 and is implemented in, for instance, a chip set including a processor and a memory as shown in FIG. 14.

In step 223, the channel manager platform 109 configures a first system to implement one or more first points at a first schema. In one embodiment, the one or more first points are provided based on a determined usage of the first system or a first service associated with the first system. In one example embodiment, the channel manager platform 109 receives an input via a user interface element of a UE 101 associated with a registered user, wherein the input includes a plurality of requests for services from registered service providers. Thereafter, the channel manager platform 109 configures a first system to implement one or more first points upon confirmation of the request for the plurality of services. The one or more points are based on the amount spent by the registered user for the requested service, and are set at a first schema, e.g., a value that is assigned to the one or more points. In one embodiment, the data is mapped with a pre-defined schema, or set of constraints, that defines how it is structured and organized for analysis. In one embodiment, a schema is a representation of the integrity rules, arrangement, relationships, and contents of data. A data structure is a manifestation of a specific data schema for a specific purpose within the system's data resource. In another embodiment, a schema is a representation of the structure of the database that illustrates what kind of data is stored in the database. In distributed database management environments, it is possible to distribute new schemas as well as modify the existing schemas of the databases of the system in a flexible and controllable manner.

In step 225, the channel manager platform 109 configures a second system to implement one or more second points at a second schema. In one embodiment, the one or more second points are provided based on a determined usage of the second system or a second service associated with the second system. In one example embodiment, the channel manager platform 109 receives a confirmation from the registered service providers that a service has been successfully requested by the registered user. Thereafter, the channel manager platform 109 configures a second system to implement one or more second points, wherein the one or more second points are based on the amount for the requested service, and are set at a second schema, e.g., a value that is assigned to the one or more points.

In step 227, the channel manager platform 109 configures an electronic interface to receive a request from a user device to apply one or more user points from the first system or the first service to the second system or the second service. In one example embodiment, an electronic interface, e.g., an interface between the first system and the second system, receives a request from the user interface element of a registered UE 101 to redeem the one or more user points from the first system to the second system.

In step 229, the channel manager platform 109 configures the electronic interface to transform the one or more user points from the first schema to a fixed schema and then from the fixed schema to the second schema. In one example embodiment, during the calculation of one or more user points, the electronic interface implements constants to convert the amount spent by the registered user for a service, e.g., $1=2 points. A registered user pays $100 from his/her user account to successfully request for a service from the registered service providers. The electronic interface may recompute the amount spent by the registered user to a fixed schema, e.g., $100=200 points. Thereafter, the electronic interface calculates the available user points on a fixed schema to second schema, e.g., 200 points=$2.

In step 231, the channel manager platform 109 configures an electronic interface to transmit the one or more user points transformed at the second schema via the electronic interface to the second system. As previously discussed, once the electronic interface transforms the user points from the first schema, e.g., amount spent by the registered user for a service, to a fixed schema, e.g., conversion of the amount spent to points by implementing constants. The electronic interface calculates the available user points on a fixed schema to a second schema via the electronic interface to the second system.

FIG. 2C is a flowchart of a process for retrieving a contract between different reward systems from a blockchain, according to one embodiment. In one embodiment, the channel manager platform 109 performs the process 214 and is implemented in, for instance, a chip set including a processor and a memory as shown in FIG. 14.

In step 233, the channel manager platform 109 retrieves a contract between the first system or the first service and the second system or the second service from a blockchain. The blockchain is configured to propagate one or more branching blockchains, and wherein the branching blockchains is configured to propagate one or more additional branching blockchains. In one embodiment, the one or more user points are transformed based on the contract retrieved from blockchain 213. In general terms, blockchain 213 is an immutable cryptographically linked list of data blocks called a ledger and maintained within a distributed peer-to-peer framework such as a consortium network 215 with nodes 217a-217n (also collectively referred to as nodes 217). These nodes 217, for instance, each maintains an identical copy of the ledger by appending transactions that have been validated by a consensus protocol, grouped into blocks. Each block generally contains a cryptographic hash of previous block, a timestamp and transaction data (e.g., generally represented as a Merkle tree). The concept of blockchain 213 does not require a trusted authority or central server as all nodes 217 in the network 215 are equal and act as transaction initiators and validators at the same time, thereby providing full visibility of the blockchain 213 (e.g., the trust chain for consent transactions) across all nodes 217. All blocks that are added to blockchain 213 are unalterable and changing any of them retroactively would require alteration of all subsequent blocks which in turn requires consensus of network majority.

In a permissionless blockchain 213, virtually anyone can participate, and every participant is anonymous. In such a context, there can be no trust other than that the state of the blockchain 213, prior to a certain depth, is immutable. In order to mitigate this absence of trust, permissionless blockchains 213 typically employ a “mined” native cryptocurrency or transaction fees to provide economic incentive to offset the costs of participating in a form of byzantine fault tolerant (BFT) consensus based on “proof of work” (PoW) or “prove of stake” (PoS) algorithm.

Permissioned blockchains 213, on the other hand, operate a blockchain 213 amongst a set of known, identified and often vetted participants operating under a governance model that yields a certain degree of trust. Private and permission-based blockchains 213, for instance, are generally proposed for the business or enterprise sector. Permissioned blockchains 213 widely use an access control layer to govern who can access the distributed network 215. In one embodiment, new members are invited to join the consortium network 215 by a network owner (starter) or other members with the sufficient authorities applied by a set of rules or policies. By way of example, there are different types of access control mechanisms such as but not limited to: existing participants can invite newcomers; regulatory authority can issue a license or certificate for participation etc.

In one embodiment, the blockchain network (e.g., the consortium network 215) includes a smart contract or chaincode layer 219 comprising one or more smart contracts or chaincodes 221a-221m (also collectively referred to as chaincodes 221 or smart contracts 221). Each smart contract or chaincode 221 is automatically executable computer code running on top of a blockchain network (e.g., the consortium network 215), being encoded into blockchain 213 itself. It is noted that the terms “smart contract” and “chaincode” are used interchangeably even though chaincode is the Hyperledger Fabric implementation specific term for smart contract. Each smart contract or chaincode 221, for instance, contains a set of rules and conditions under which the parties of the “smart” contract agree to interact with each other. For example, a smart contract or chaincode 221 can initiate a recording of a request on the blockchain 213 after the nodes 217 verify that a payment has been made. In this way, the smart contract code or chaincode 221 facilitates, verifies, and enforces negotiation of agreements or transactions between parties.

For example, considering a blockchain 213 as the data, the smart contract or chaincode 221 is a logic which allows to the manipulation of virtual assets. As described above, the chaincode 221 is executed (e.g., by nodes 217 of the consortium network 215 to reach a consensus) when programmed conditions are met. The advantage of the smart contract or chaincode 221 is that it does not require third-parties being involved in the agreement based on a blockchain 213. All transactions made are validated by required members or nodes 217 using the instantiations of the chaincode 221 and stored in the blockchain 213 only when consensus is met. In one embodiment, a smart contract or chaincode 221 is a secure and, in most cases, public way of managing assets, agreements, registries, etc. including but not limited to points to at least one registered user for acquisition of a registered service.

FIG. 2D is a flowchart of a process for redemption of the transformed user points, according to one embodiment. In one embodiment, the channel manager platform 109 performs the process 216 and is implemented in, for instance, a chip set including a processor and a memory as shown in FIG. 14.

In step 235, the channel manager platform 109 generates a data record indicating redemption of the one or more transformed user points. In one embodiment, the data record comprises a plurality of data fields, and the plurality of data fields includes textual data, numerical data, dates, currencies, and other data in chronological order. The data records comprise static and non-static data elements. The static data elements are not manipulated (generated, erased, altered, etc.) or only sporadically manipulated by the applications running on the application server. The non-static data elements, on the other hand, are short-lived compared with the static data elements and, in accordance with the particular requirements, are continuously generated, erased, processed, etc. by the application programs. In one embodiment, the data record indicating redemption of the one or more transformed user points are updated in real-time.

In step 237, the channel manager platform 109 transmits the data record to the first system, the first service, the second system, the second service, or a combination thereof. In one embodiment, the channel manager platform 109 may monitor the data records in real-time and may extract and publish a report on redemption of the transformed user points upon request or per schedule (daily, weekly, monthly, annually, and the like). Thereafter, the channel manager platform 109 transmits the report to the first system and/or the second system.

FIG. 2E is a flowchart of a process for recommending a service to a registered user, according to one embodiment. In one embodiment, the channel manager platform 109 performs the process 218 and is implemented in, for instance, a chip set including a processor and a memory as shown in FIG. 14.

In step 239, the channel manager platform 109 monitors, in real-time, a change in convertibility between the one or more first points at the first schema and the one or more second points at the second schema. In one embodiment, the one or more first points are the amount paid by the registered users in a first currency, and the one or more second points are the amount charged by the registered service provider in a second currency. In one example embodiment, the amount paid by the registered users in a first currency, e.g., U.S. Dollars, to a service charged by the registered service provider in a second currency, e.g., South Korean Won. The channel manager platform 109 monitors the exchange rate between the first currency and the second currency from the time of confirmation of the service.

In step 241, the channel manager platform 109 recommends at least one registered user of the user device to apply the one or more user points from the first system or the first service to the second system or the second service based on the change in convertibility. In one example embodiment, the channel manager platform 109 monitors the exchange rate change between the user points from the first system and the second system from the time of confirmation of the service. The user points from the first system are based on a constant, e.g., $1=2 points, and the user points from the second system are also based on a constant, e.g., 100 points=$1. The channel manager platform 109 notifies a registered user to take profit based on the convertibility rate by trading the user points from the first system to the second system.

In step 243, the channel manager platform 109 processes activity information, contextual information, or a combination thereof associated with at least one registered user of the user device to predict a next service for the at least one registered user. In one example embodiment, activity information includes, but is not limited to, data or information regarding application use information, service use information, device use information, sensor data, and/or online activities of the registered users. In one example embodiment, contextual information includes, but is not limited to, user behavior information, user profile information, purchase history information, and/or historical user information and interests.

In step 245, the channel manager platform 109 generates a presentation of the next service, one or more points associated with the next service, or a combination thereof in a user interface of the device. In one example embodiment, the presentation includes an aural notification, a visual notification, or a combination thereof. The registered user can interact with the user interface element in the UE 101 pursuant to the aural and/or visual notifications to select the next service.

In step 247, the channel manager platform 109 receives a request via a user interface element of the user device for the next service. Subsequently, the first system implements the one or more points associated with the next service at a first schema upon determined usage of the next service.

In step 249, the channel manager platform 109 transfers automatically and in real-time the one or more user points from the first schema to a fixed schema and then from the fixed schema to the second schema.

FIG. 2F is a flowchart of a process for determining that the user points from one schema is sufficient for another schema, according to one embodiment. In one embodiment, the channel manager platform 109 performs the process 218 and is implemented in, for instance, a chip set including a processor and a memory as shown in FIG. 14.

In step 251, the channel manager platform 109 determines the one or more user points from the first schema is sufficient for at least a portion of the one or more second points at a second schema. In one example embodiment, the one or more first points are the amount paid by the registered users in a first currency, e.g., U.S. Dollars, and the one or more second points are the amount charged by the registered service provider in a second currency, e.g., South Korean Won. The channel manager platform 109 monitors, in real-time, that the user points from the first schema is sufficient to repay a portion of the second points on the second schema before transforming the user points.

FIG. 2G is a flowchart of a process for updating the user points, according to one embodiment. In one embodiment, the channel manager platform 109 performs the process 222 and is implemented in, for instance, a chip set including a processor and a memory as shown in FIG. 14.

In step 253, the channel manager platform 109 updates, in real-time, the one or more user points in the first system, the second system, or a combination thereof. In one embodiment, the one or more first points in the first system is reduced and the one or more second points in the second system is increased based upon the transmitted one or more user points to the second system.

In step 255, the channel manager platform 109 presents the updated one or more user points in a user interface of the device. In one example embodiment, the presentation includes an aural notification, a visual notification, or a combination thereof.

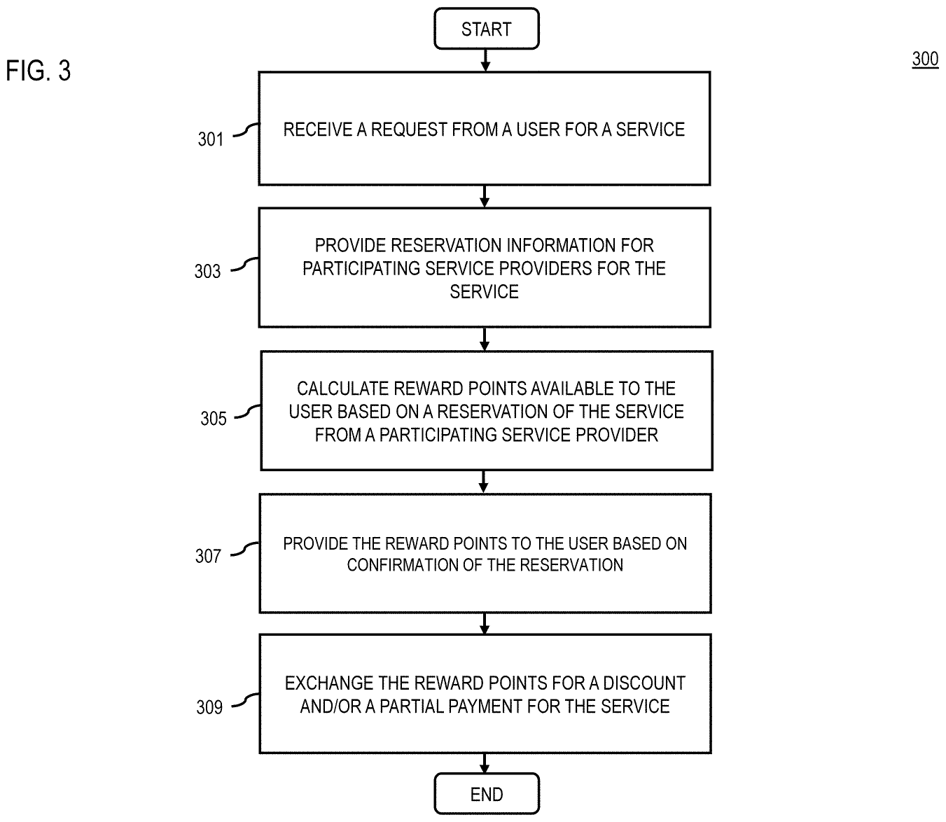

FIG. 3 is a flowchart of a process for providing points to a registered user for acquisition of a registered service, and exchanging the points as a partial payment for the registered service, according to one embodiment. In one embodiment, the channel manager platform 109 performs the process 300 and is implemented in, for instance, a chip set including a processor and a memory as shown in FIG. 14.

In step 301, the channel manager platform 109 receives a request from at least one user for at least one service. In one embodiment, the at least one user includes a registered user, a visiting user, or a combination thereof. In another embodiment, the at least one service includes a hotel booking service. In one example embodiment, a registered user A sends a request via his/her UE 101 for a hotel room in ABC city.

In step 303, the channel manager platform 109 provides reservation information for one or more participating service providers for the at least one service based, at least in part, on preference information of the at least one user. In one embodiment, the reservation information includes hotel information, hotel check-in time, hotel check-out time, hotel check-in date, hotel check-out date, room rates, or any other suitable data related to reservation management. In another embodiment, hotel information includes hotel names, hotel addresses, hotel amenities, hotel quality ratings, room availability and so on. In a further embodiment, preference information includes hotel preferences, room preferences, amenity preferences, pricing preferences, location preferences, or a combination thereof. In one example embodiment, the channel manager platform 109 may process user A's travel data (e.g., history of user A's external reservations, such as, theatre, sports facilities, museums, zoo, restaurants etc.) and preference information to provide user A with reservation information for one or more participating hotel in ABC city. In one scenario, the channel manager platform 109 determines that user A enjoys swimming and visiting museums. As a result, the channel manager platform 109 provides user A with reservation information for one or more participating hotels with swimming pools and has close proximity to museums.

In step 305, the channel manager platform 109 calculates one or more points available to the at least one user based, at least in part, on a reservation for the at least one service from at least one participating service provider. In one embodiment, the one or more points are rewards points for reserving a service from the participating service providers. In another embodiment, the one or more points are loyalty points for becoming a registered member of the booking service. In one embodiment, during calculation of the points there are few constants, such as:
100 points=$1;
Commission to points ratio=50% (part of commission which goes to the customer in form of points);
Point payment minimum=500 (when paying with points, the number of points used must be higher or equal to 500).
Discounted booking default point value: 100 points=$3 (this can be changed by hotel manager in discount definition section).

In another embodiment, the channel manager platform 109 provides higher points to user A for booking a room in a hotel that provides higher commission amount to the service provider. In one example embodiment, user A is a visiting or a guest user. The channel manager platform 109 may provide user A with loyalty points for registering with the system and becoming a registered user. In one scenario, channel manager platform 109 may provide user A with 10,000 points to register with the system. Then, user A may utilize these 10,000 points to get a lower price while booking a hotel room.

In step 307, the channel manager platform 109 provides the one or more points to the at least one user based, at least in part, on confirmation of the reservation for the at least one service. In one example embodiment, user A is provided with 10,000 points to his point account upon reserving a hotel room. Now, user A has a total of 40,000 points in his point account. The reservation amount for the hotel is $400 and he is going to pay 20,000 points to get a lower price. The hotel booking service of the channel manager platform 109 has a 15% commission negotiated with the hotel. Therefore, the calculation is as follows:
Amount paid by points (discount)=20000/100=$200
New (discounted) total for the reservation=$400−$200=$200
Service providers commission=$200*15%=$30
Points earned by User A=$30*50%*100=1500 points
Payment for a hotel=$200+20000 points.

In step 309, the channel manager platform 109 exchanges the one or more points for a discount, a partial payment, or a combination thereof for the at least one service based, at least in part, on a pre-set criteria, a purchase amount of the at least one service, or a combination thereof.

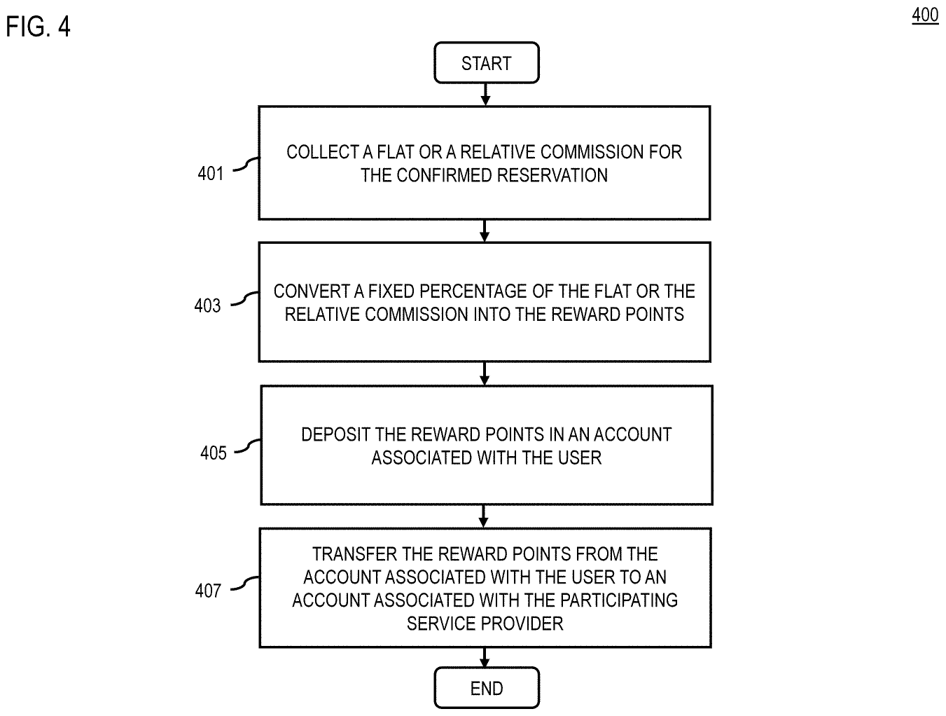

FIG. 4 is a flowchart of a process for calculating points for a registered user, and depositing the points in a point account associated with the registered user, according to one embodiment. In one embodiment, the channel manager platform 109 performs the process 400 and is implemented in, for instance, a chip set including a processor and a memory as shown in FIG. 14.

In step 401, the channel manager platform 109 calculates the one or more points by collecting a flat or a relative commission for the reservation confirmed by the at least one user. In one example embodiment, the channel manager platform 109 may have a fixed commission scheme negotiated with one or more participating hotels for every confirmed reservation. In another example embodiment, the channel manager platform 109 may have a relative commission for participating hotels giving higher commission to the service providers. Higher commission yields higher points for the users.

In step 403, the channel manager platform 109 calculates the one or more points by converting a fixed percentage of the flat or the relative commission into the one or more points. In one example embodiment, hotel booking service of the channel manager platform 109 has a 10% commission negotiated with a hotel. The commission is calculated on the discounted value of the reservation (i.e., reservation amount less amount paid by points). The calculation is as follows:
The reservation cost for a hotel room=$200
Amount paid by points=10,000/10=$100
New discounted value for the reservation=$200−$100=$100
Service providers commission=$100*10%*100=$10

In the above example, the service provider's commission is $10. Next, the channel manager platform 109 calculates commission which goes to the user in the form of reward points. For example, the commission to point's ratio is 50% of the service provider's commission. The calculation is as follows:
Points earned by the user=$10*50%*100=500 points

In step 405, the channel manager platform 109 deposits the one or more points in at least one account associated with the at least one user. In one example embodiment, the 500 points earned by the user is transferred to his or her account.

In step 407, the channel manager platform 109 exchanges the one or more points by transferring automatically the one or more points from the at least one account associated with the at least one user to at least one account associated with the at least one participating service provider based, at least in part, on confirmation of the reservation for the at least one service. In one embodiment, the one or more points are above the minimum threshold limit required for transferring the one or more points between accounts. In one example embodiment, the minimum points required to make a payment is 500 points. The user needs at least 500 points or more than 500 points to pay for a service.

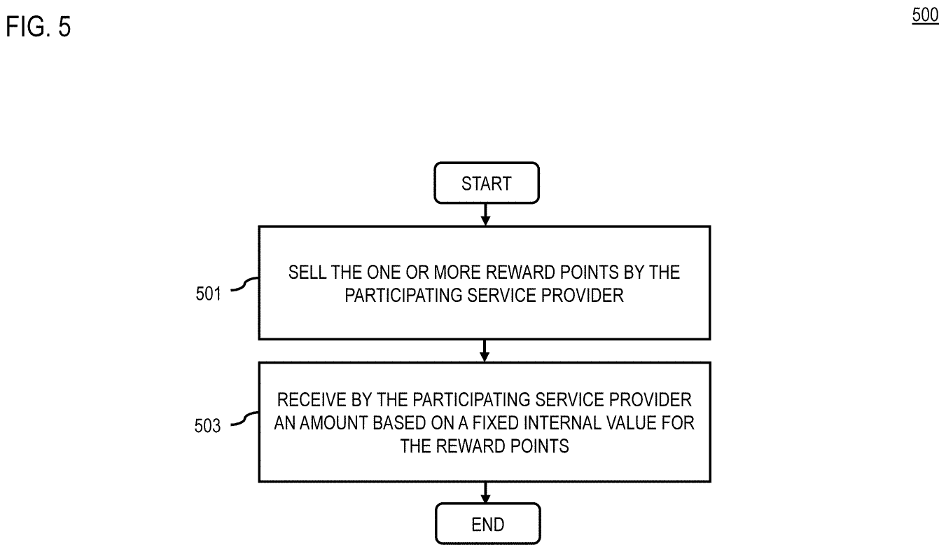

FIG. 5 is a flowchart of a process for selling one or more points by the participating service providers, according to one embodiment. In one embodiment, the channel manager platform 109 performs the process 500 and is implemented in, for instance, a chip set including a processor and a memory as shown in FIG. 14.

In step 501, the channel manager platform 109 transfers the one or more points of the at least one participating service provider. In one example embodiment, a participating hotel may transfer the one or more points from its account to the account of the channel manager platform 109 in exchange for an amount.

In step 503, the channel manager platform 109 provides the at least one participating service provider an amount based, at least in part, on a fixed internal value for the one or more points. In one example embodiment, the channel manager platform 109 may receive 10,000 points from the account of the participating hotel. Then, the channel manager platform 109 determines an amount for the points transferred by the participating hotel based on a fixed internal value, for example, $1 equals 100 points. Subsequently, the channel manager platform 109 transfers $100 to the account of the participating hotel.

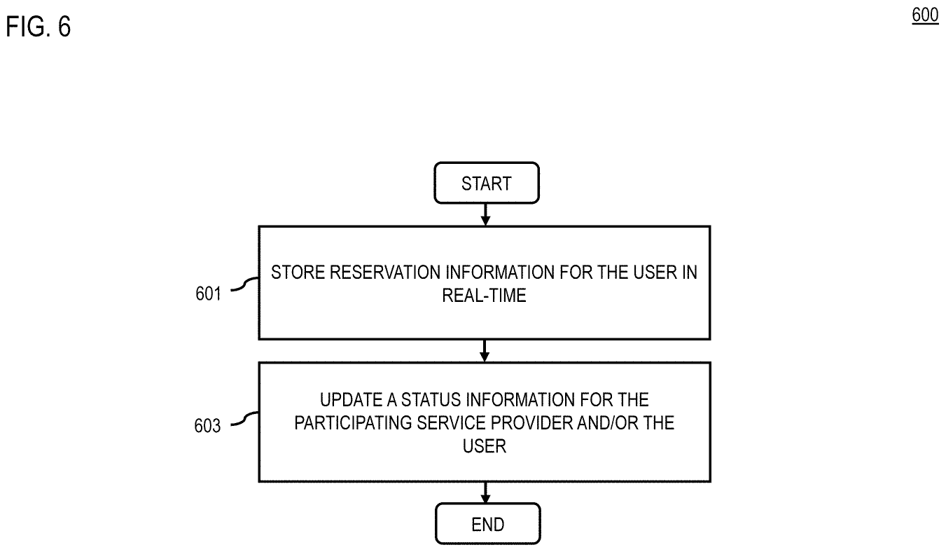

FIG. 6 is a flowchart of a process for storing reservation information and updating status information, according to one embodiment. In one embodiment, the channel manager platform 109 performs the process 600 and is implemented in, for instance, a chip set including a processor and a memory as shown in FIG. 14.

In step 601, the channel manager platform 109 stores reservation information for the at least one user in real-time. In one embodiment, the reservation information includes confirmed reservations, pending reservations, cancelled reservations, name of the hotel with confirmed reservations, name of the hotel with pending reservations, name of the hotel with cancelled reservations, or a combination thereof.

In step 603, the channel manager platform 109 updates a status information for the at least one participating service provider, the at least one user, or a combination thereof based, at least in part, on the confirmation of the reservation for the at least one service. In one example embodiment, user ABC may book room 123 at hotel XYZ. Then, the channel manager platform 109 may update the status information for room 123 at hotel XYZ as “booked.” Further, the channel manager platform 109 may update status information for user ABC as “reservation confirmed.”

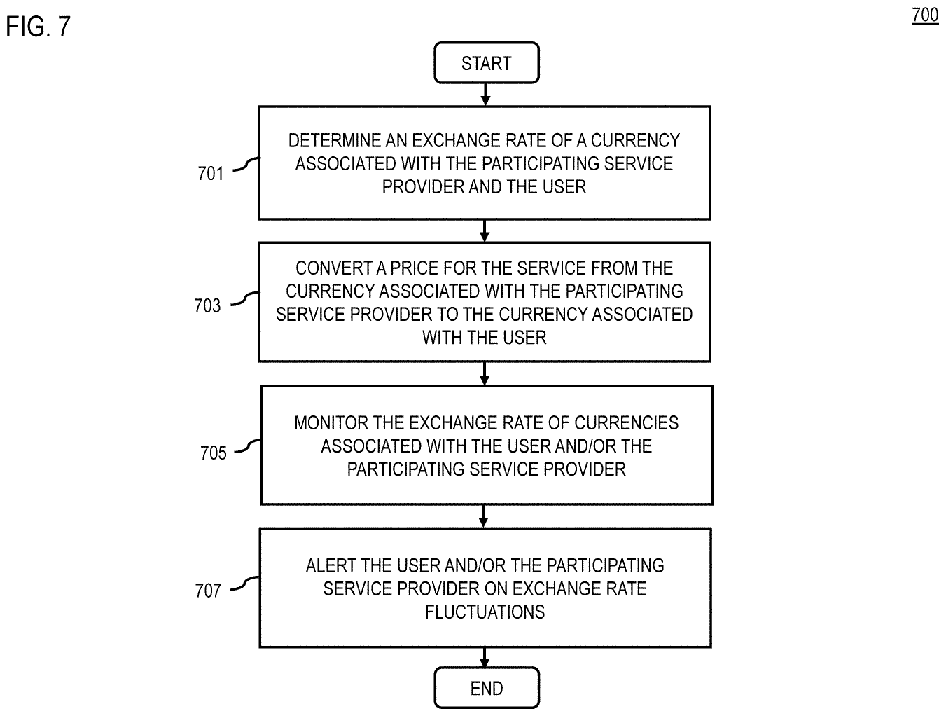

FIG. 7 is a flowchart of a process for monitoring exchange rate of currencies associated with participating service provider and the user, according to one embodiment. In one embodiment, the channel manager platform 109 performs the process 700 and is implemented in, for instance, a chip set including a processor and a memory as shown in FIG. 14.

In step 701, the channel manager platform 109 determines an exchange rate of a currency associated with the at least one participating service provider to a currency associated with the at least one user at time of confirming the reservation. In one example embodiment, user ABC in the United States books a room at hotel XYZ in India. The total cost for the room was 10,000 INR. The channel manager platform 109 determines the exchange rate between INR to dollar at the time of booking the room at hotel XYZ.

In step 703, the channel manager platform 109 converts a price for the at least one service from the currency associated with the at least one participating service provider to the currency associated with the at least one user based on the exchange rate. In one embodiment, the channel manager platform 109 maintains a data table in a database that provides exchange rates for converting points earned at one hotel to points or payment amounts for another hotel. In one example embodiment, hotel ABC is located in China and its base currency is RMB. The amount for booking a room at hotel ABC is 6,000 RMB, and user Z is going to pay half of the amount with his points. The hotel booking service of the channel manager platform 109 has a 15% commission negotiated with the hotel. Then, the channel manager platform 109 performs the following calculations:
Booking time exchange rate: $1=6 RMB
Price in US Dollar=6000 RMB/6=$1000
Amount paid by points=$500=50,000 points=3000 RMB
Amount paid by credit card=3000 RMB=$500
Hotel ABC is going to collect: 3000 RMB+50,000 points
Service providers commission=$500*10%=$50
Points earned by user Z=$50*50%*100=2500 points

The 2500 points earned by user Z combined with other accumulated points in his/her account may be utilized in his/her future booking with any participating hotels.

In step 705, the channel manager platform 109 monitors the exchange rate of one or more currencies associated with the at least one user, the at least one participating service provider, or a combination thereof continuously, periodically, according to a schedule, on demand, or a combination thereof.

In step 707, the channel manager platform 109 alerts the at least one user, the at least one participating service provider, or a combination thereof on exchange rate fluctuations. In one example embodiment, hotel ABC decides to sell the points a month later to the hotel booking services. At that point, the channel manager platform 109 performs the following calculations:
Current exchange rate: $1=7 RMB
Amount of points to be sold=50,000 pts=$500
Amount in RMB=3500 RMB
Profit fora hotel=3500 RMB−3000 RMB=500 RMB

In the above example, hotel ABC made a profit of 500 RMB by deciding to sell the points a month later to the hotel booking services. The channel manager platform 109 assists the participating hotels in reaching sales decision by monitoring the exchange rate fluctuations. The channel manager platform 109 alerts the participating hotels in any currency exchange related risk, e.g., a drop in the exchange rate from RMB to US dollar.

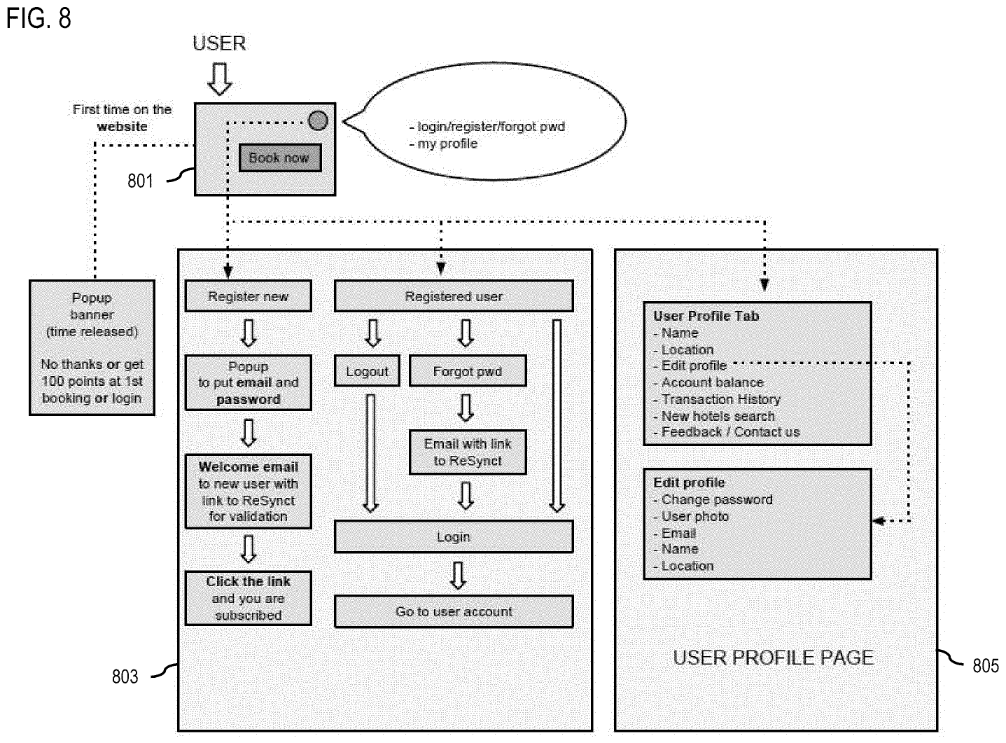

FIG. 8 is a diagram that represents a registration workflow, according to various embodiments. In one scenario, a visiting user may see a popup banner or a registration widget for a hotel booking service whereupon the user may create an account with the service (801). The registration process may involve redirecting the user to a profile page (805) wherein a user is requested to enter his/her profile information (e.g., name, address, email, username, password, etc.). Then, the email address of the user is verified (803), upon validation of the email address the visiting user becomes a member. As a member, the user can authenticate on the hotel's websites or in their booking engines, access his/her account, collect points for every reservation with the participating hotels (if the reservation is done through booking engine of the channel manager platform 109), and pay for the reservation with points (partially or completely). The collection and redemption of points is based on authentication and approval of the members by the channel manager platform 109. In another scenario, one or more hotels may register into the hotel booking program by signing up a contract whereupon their information is integrated into the booking system of the channel manager platform 109. The registration of hotels may also involve placing login widget and banner of the hotel booking service on the hotel's website. Further, the participating hotels may have access to the hotel booking service's backend, history of the booking service's related reservations, accounting history, special discounts management, loyalty point, account transactions history, etc.

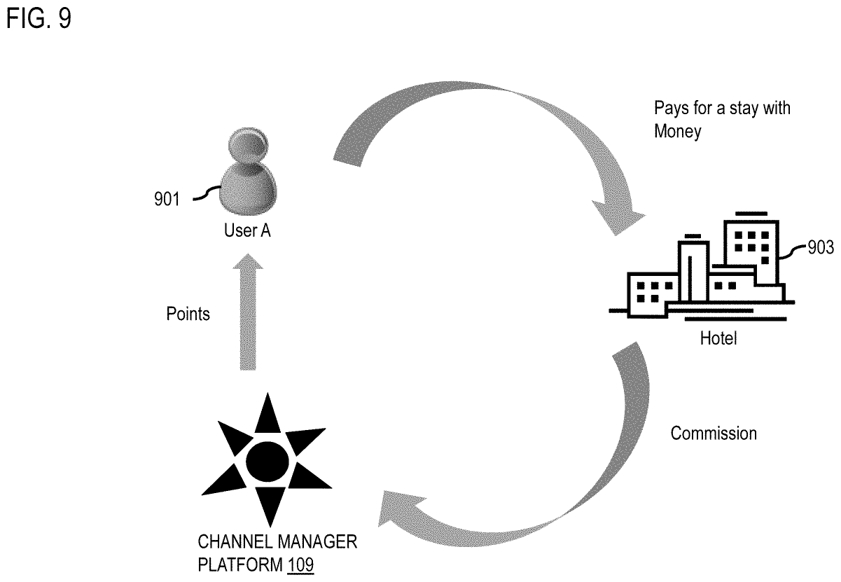

FIG. 9 is a diagram utilized in the processes of earning points for at least one registered user, according to various embodiments. In one scenario, a registered user A (910) reserves a room in a participating hotel (903). Every time a registered user makes a reservation (which is at least partially paid with money) in any participating hotels, he/she earns certain amount of points. As discussed, the channel manager platform 109 collects a flat or relative commission for every reservation made by the registered users in the participating hotels. In one scenario, the higher the commission amount to the service provider, the higher the point reward to the members for the reservation with a participating hotel (i.e., hotels giving higher commission to the service provider is more attractive for members). Subsequently, the channel manager platform 109 converts a fixed percentage of the received commission into points for user A (901). These converted points are deposited to user A's (901) point account.

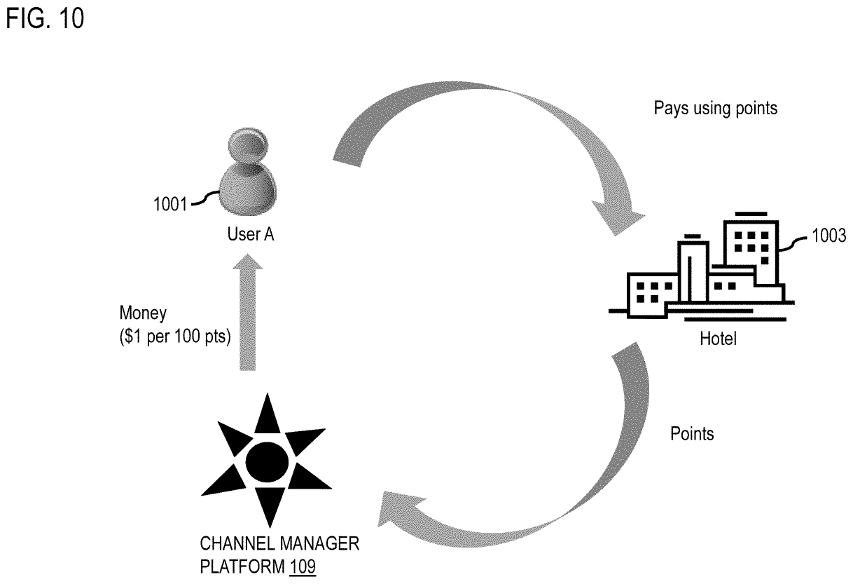

FIG. 10 is a diagram utilized in the processes of redeeming points for at least one registered user, according to various embodiments. In one scenario, a registered user A (1001) may use his/her points to get a discount on later bookings in any participating hotel (1003). The channel manager platform 109 may determine a fixed internal value of the points for their members, for example, $1 equals to 100 points. In one example embodiment, user A (1001) may have 1,000 points from previous transactions. If user A (1001) spends $100 while booking a room in a hotel (1003), the channel manager platform 109 may transfer user A's (1001) points (i.e., 1,000 points) to the participating hotel's (1003) point account. Since user A used points to get a discount, these used points are immediately removed from members' account ensuring that the members cannot use these points for making another reservation. These points are not immediately added to the hotel's account, but are deemed “pending” with the reservation itself. Once, the reservation is confirmed, the participating hotels can sell these points to the collect money from the channel manager platform 109 (e.g., the hotel may generate invoices for the valid and confirmed reservation that was not invoiced). In another scenario, the channel manager platform 109 may offer special relative discounts for specific dates and rooms to motivate members to collect points and for hotels to invest. In other words customer gets extra discount only in case he/she pays with points for the discounted reservation (at least partially).

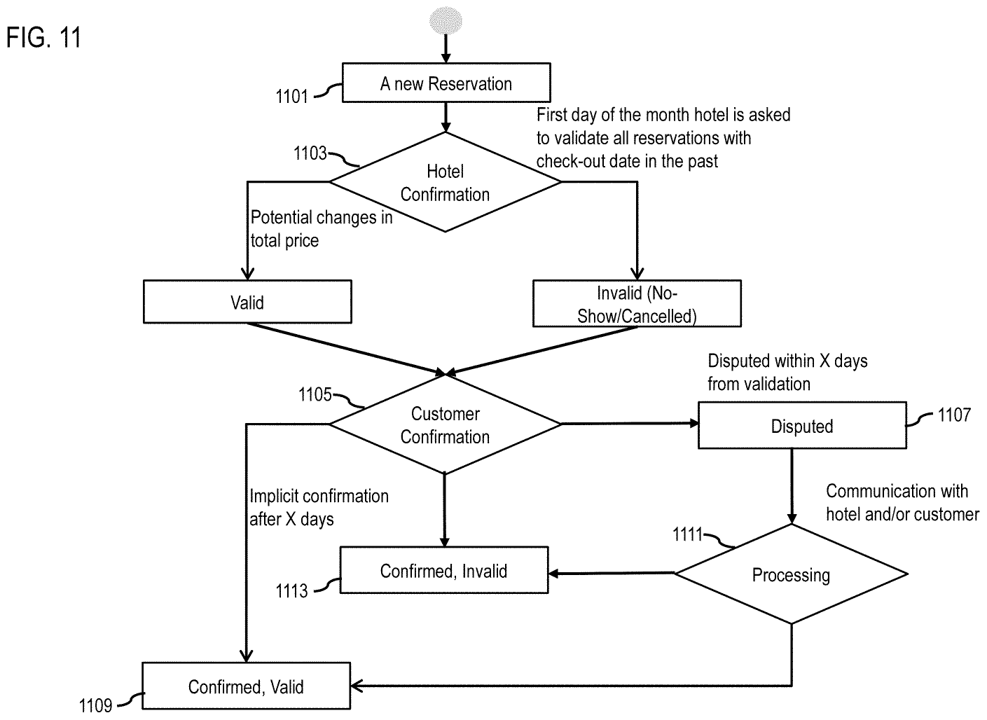

FIG. 11 is a flowchart of a process that depicts the reservation life cycle, according to one example embodiment. In one embodiment, the channel manager platform 109 may request one or more participating hotels to provide information on each and every reservation with check-out dates in the past at a particular time period (e.g., 1st day of every month). In step 1101, all new reservations with check-out dates in the past are sent to the hotel managers for validation (and possible edit). The hotel managers have a certain time period (e.g., validation deadline) to validate or invalidate the reservation (step 1103). In step 1105, all validated reservation (both valid and invalid) not confirmed by the customer is sent to the customer for confirmation. The customer has a certain time period (e.g., confirmation deadline) to confirm or dispute (step 1107) the reservation. In step 1109, the channel manager platform 109 may confirm all the validated reservations which were not disputed by the customer after a certain time period. In one scenario, all reservations not confirmed nor disputed by customers within the confirmation deadline is auto-confirmed. If a customer disputes the reservation (step 1107), he/she needs to provide a reason for the dispute, and the disputed reservation is sent for processing (step 1111). In addition, if a customer confirmation is determined to be invalid (step 1113) by the channel manager platform 109 it is sent for further processing (step 1111). Subsequently, a valid reservation that was disputed by a customer or an invalid confirmation may be confirmed and validated by the channel manager platform 109 (step 1109) after processing.

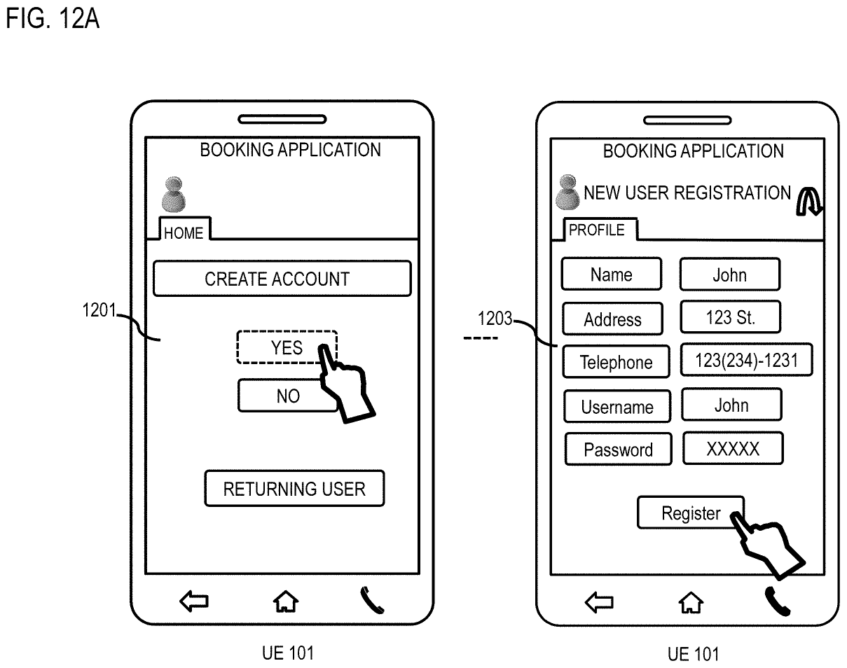

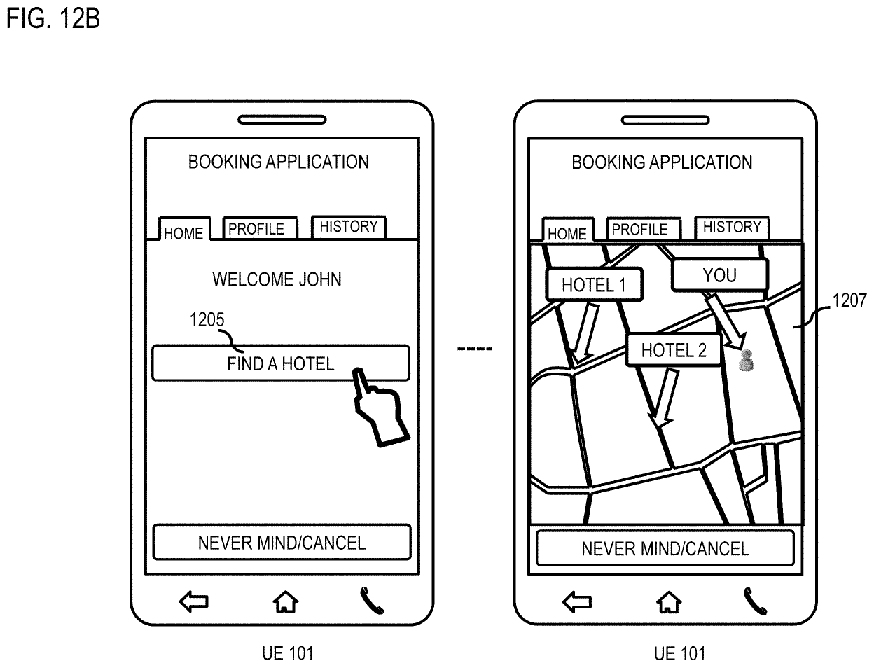

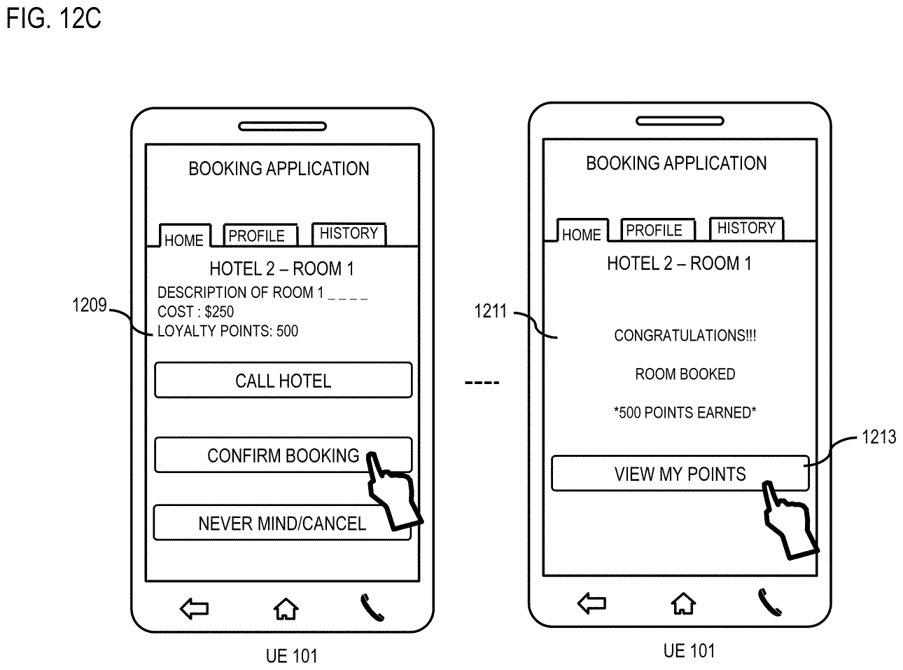

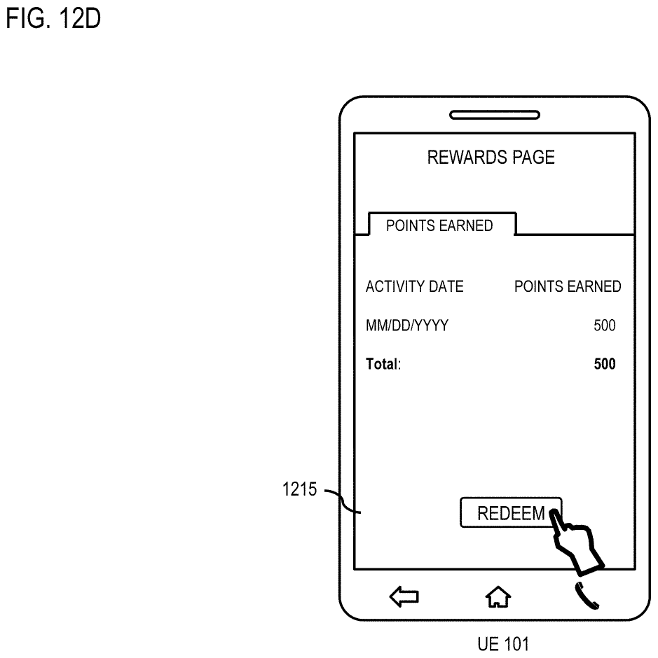

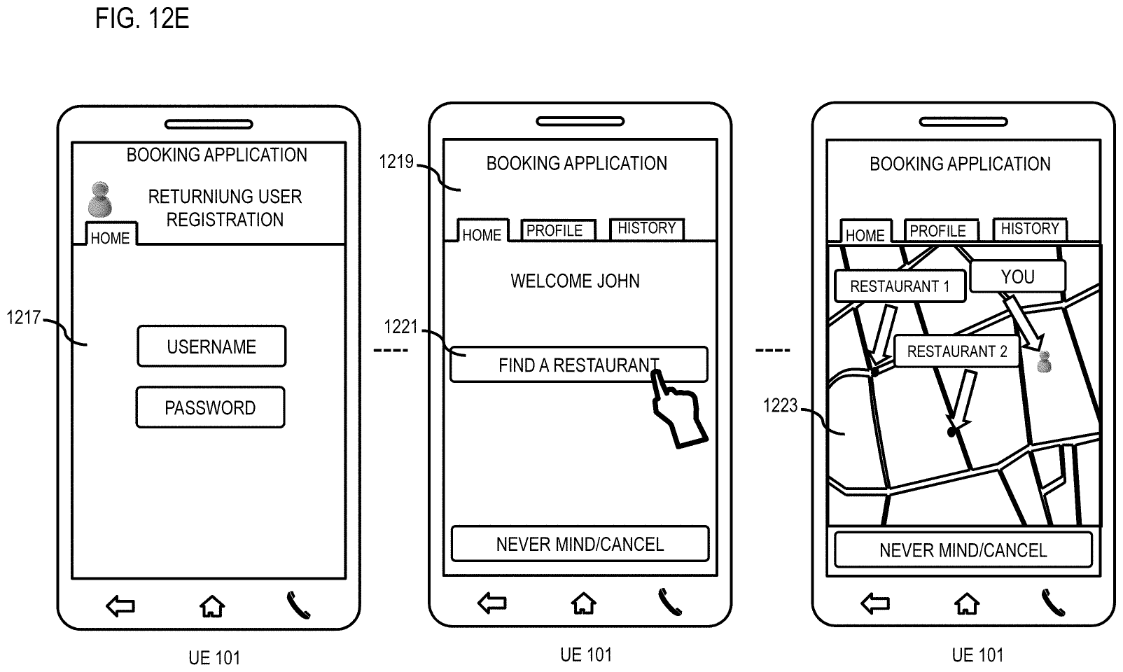

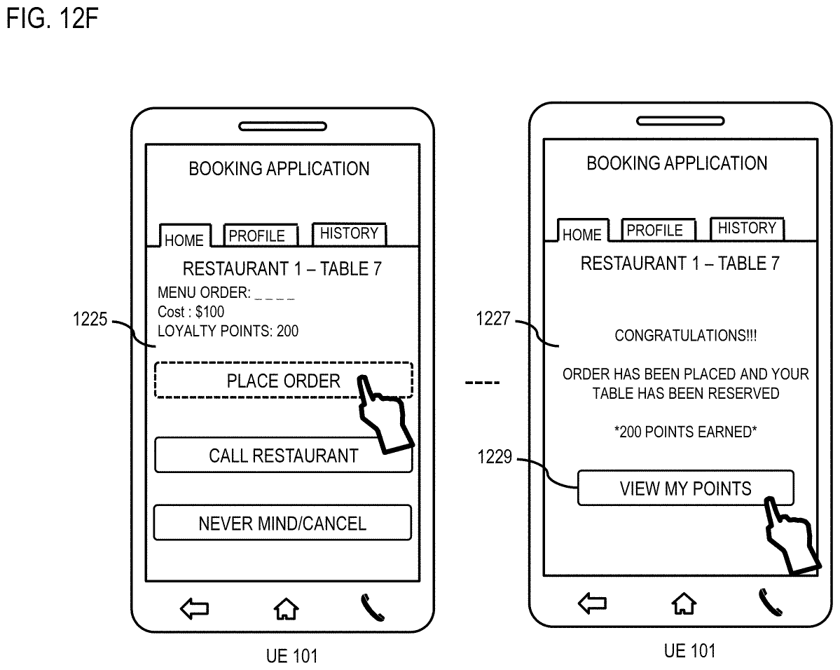

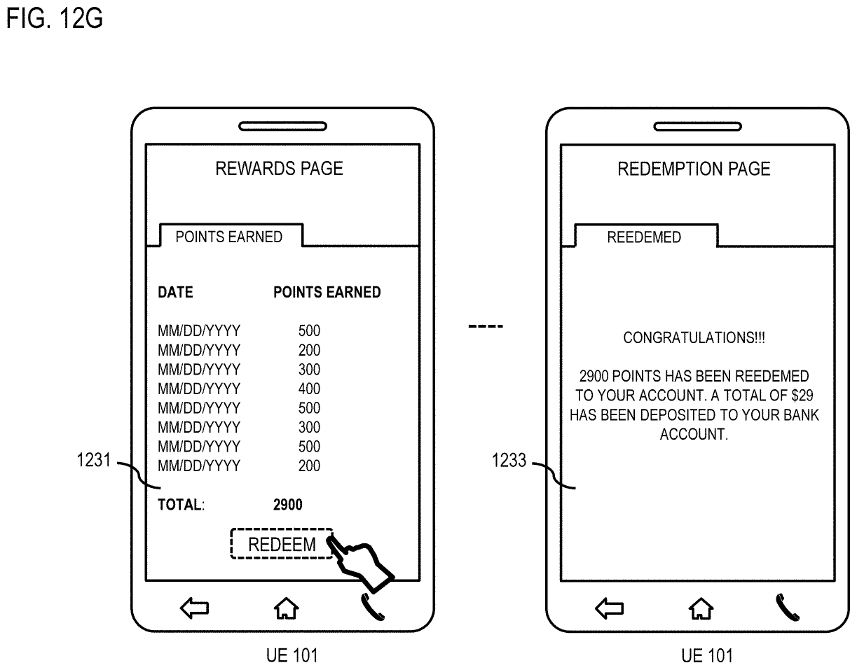

FIGS. 12A-12D are user interface diagrams that illustrate a registration process for new users to make reservations and earn reward points, according to various example embodiments. Usually, a user may use his/her UE 101 to do a painstaking search for a nearby hotel keeping in mind location and/or pricing and/or current availability and/or services availability. FIGS. 12A-12D provides users with an opportunity to use a booking application in their UE 101 to check pricing, location, room availability, service availability, and various other information associated with one or more participating hotels with one click. FIG. 12A represents a registration page for one or more users. A user may create an account (1201) by entering his/her profile information (1203) to access the services of the booking application. The registration page is simple and user-friendly.

In FIG. 12B, a user may send a request for a hotel search via his/her UE 101 by clicking “find a hotel” tab (1205). Then, the channel manager platform 109 may search amongst the participating hotels based, at least in part, on proximity information, pricing information, availability information, and so on. Subsequently, the user is presented with a list of recommended hotels superimposed on a map (1207) in a user interface of his/her UE 101.

In FIG. 12C, the channel manager platform 109 may display room information, pricing information, and points for at least one selected hotel (e.g., hotel 2) in at least one UE 101 (1209). The user may book the hotel by clicking “confirm booking” tab whereupon the user earns reward points upon booking confirmation (1211). The user may select “view my points” tab (1213) whereupon the channel manager platform 109 presents user interface 1215 that displays the reward points earned by the user based on his/her online transactions (as depicted in FIG. 12D). In one example embodiment, the user may receive rewards points for offline transactions, e.g., the user visits a shop registered with the rewards program and purchases few items. The user can then scan the barcode in the billing receipt via the booking application or enter the receipt number in the booking application, whereupon the channel manager platform 109 retrieves the information from the registered shop. The channel manager platform 109 then calculates the rewards points for the user and displays the rewards points in the user interface of UE 101 associated with the user.

FIGS. 12E-12G are user interface diagrams that illustrate the redemption process of reward points, according to various example embodiments. In FIG. 12E, the returning users are presented with user interface 1217, and the users may access their account by entering their credentials, e.g., username and password. Thereafter, the users are presented with user interface 1219 wherein the users can search for their interest with a click of a button. In this example embodiment, the users are requesting via his/her UE 101 by clicking “find a restaurant” tab (1221) instead of doing a painstaking search for nearby restaurants keeping in mind location and/or pricing and/or current availability and/or services availability. Thereafter, the channel manager platform 109 displays a map representation of restaurants nearby the current location of the users in a user interface of UE 101 associated with the users. The users may click on a restaurant of preference, whereupon relevant information, e.g., menu, pricing information, availability information, etc., is superimposed on the icon of the restaurant (not shown for illustrative convenience).

In FIG. 12F, once the users select the restaurant and place an order via the booking application, the channel manager platform 109 presents user interface 1225. The channel manager platform 109 may display menu order, pricing information, and reward points for the transaction, e.g., placing an order with restaurant 1, in at least one UE 101. The users may finalize the order by clicking “place order” tab, and the users earn reward points upon confirmation of the order (1227). Thereafter, the users may select “view my points” tab (1229), and the channel manager platform 109 presents user interface 1231 that displays the total reward points earned by the users based on their historical information, e.g., past transactions. The user may redeem these reward points by simply clicking the “redeem” tab, upon which the channel manager platform 109 converts the rewards points into currency, e.g., the market value of a dollar, and the amount is deposited to the bank account of the users. The users then receive confirmation notification 1233 that the reward points have been successfully redeemed and the amount has been safely deposited in their account. In another example embodiment, in an online transaction, the users may choose to pay with their rewards points, e.g., clicking “pay with reward points” tab in a user interface of UE 101, thereby invoking a process to convert accumulated reward points to a currency value such as a credit to the users' financial transaction account. After selecting a given product or service to purchase, the users provide their transaction card number and the transaction is processed as with any other transaction.

The processes described herein for providing points to at least one registered user for acquisition of a registered service, wherein payment may be partially made through automated redemption of the points from at least one point account may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

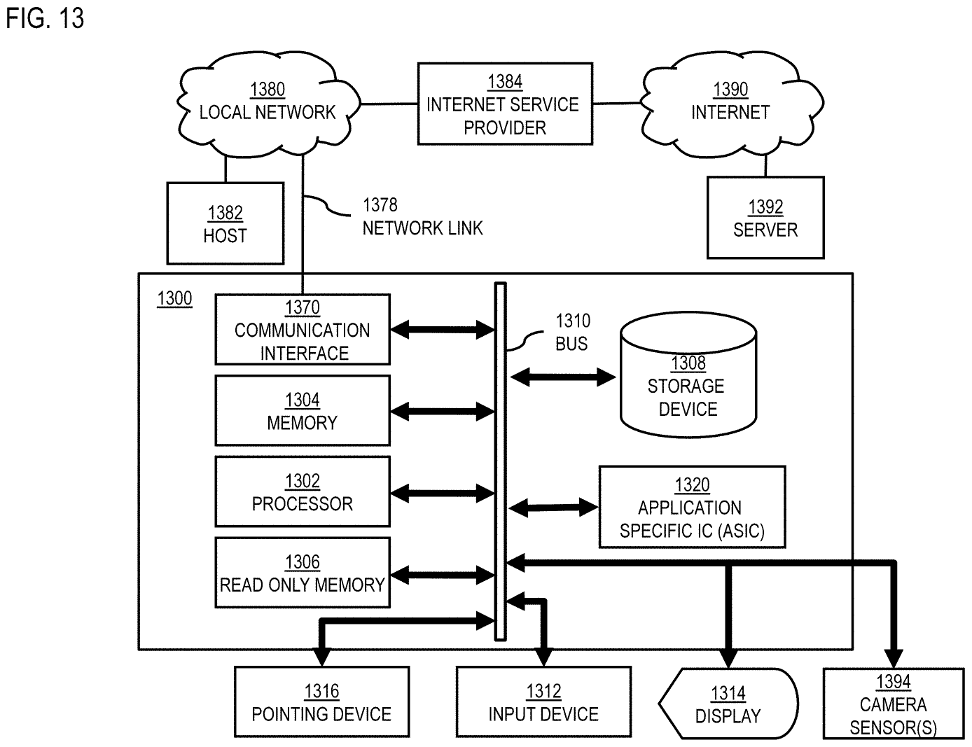

FIG. 13 illustrates a computer system 1300 upon which an embodiment of the invention may be implemented. Although computer system 1300 is depicted with respect to a particular device or equipment, it is contemplated that other devices or equipment (e.g., network elements, servers, etc.) within FIG. 13 can deploy the illustrated hardware and components of system 1300. Computer system 1300 is programmed (e.g., via computer program code or instructions) to provide points to at least one registered user for acquisition of a registered service, wherein payment may be partially made through automated redemption of the points from at least one point account as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of providing points to at least one registered user for acquisition of a registered service, wherein payment may be partially made through automated redemption of the points from at least one point account.

A bus 1310 includes one or more parallel conductors of information so that information is transferred quickly among devices coupled to the bus 1310. One or more processors 1302 for processing information are coupled with the bus 1310.

A processor (or multiple processors) 1302 performs a set of operations on information as specified by computer program code related to provide points to at least one registered user for acquisition of a registered service, wherein payment may be partially made through automated redemption of the points from at least one point account. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1300 also includes a memory 1304 coupled to bus 1310. The memory 1304, such as a random access memory (RANI) or any other dynamic storage device, stores information including processor instructions for providing points to at least one registered user for acquisition of a registered service, wherein payment may be partially made through automated redemption of the points from at least one point account. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or any other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for providing points to at least one registered user for acquisition of a registered service, wherein payment may be partially made through automated redemption of the points from at least one point account, is provided to the bus 1310 for use by the processor from an external input device 1312, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT), a liquid crystal display (LCD), a light emitting diode (LED) display, an organic LED (OLED) display, a plasma screen, or a printer for presenting text or images, and a pointing device 1316, such as a mouse, a trackball, cursor direction keys, or a motion sensor, for controlling a position of a small cursor image presented on the display 1314 and issuing commands associated with graphical elements presented on the display 1314, and one or more camera sensors 1394 for capturing, recording and causing to store one or more still and/or moving images (e.g., videos, movies, etc.) which also may comprise audio recordings. In some embodiments, for example, in embodiments in which the computer system 1300 performs all functions automatically without human input, one or more of external input device 1312, display device 1314 and pointing device 1316 may be omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of ASICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 107 for providing points to at least one registered user for acquisition of a registered service, wherein payment may be partially made through automated redemption of the points from at least one point account to the UE 101.

The term “computer-readable medium” as used herein refers to any medium that participates in providing information to processor 1302, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1308. Volatile media include, for example, dynamic memory 1304. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1320.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system 1300 can be deployed in various configurations within other computer systems, e.g., host 1382 and server 1392.

At least some embodiments of the invention are related to the use of computer system 1300 for implementing some or all of the techniques described herein. According to one embodiment of the invention, those techniques are performed by computer system 1300 in response to processor 1302 executing one or more sequences of one or more processor instructions contained in memory 1304. Such instructions, also called computer instructions, software and program code, may be read into memory 1304 from another computer-readable medium such as storage device 1308 or network link 1378. Execution of the sequences of instructions contained in memory 1304 causes processor 1302 to perform one or more of the method steps described herein. In alternative embodiments, hardware, such as ASIC 1320, may be used in place of or in combination with software to implement the invention. Thus, embodiments of the invention are not limited to any specific combination of hardware and software, unless otherwise explicitly stated herein.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server host 1392 transmits program code for a particular application, requested by a message sent from computer system 1300, through Internet 1390, ISP equipment 1384, local network 1380 and communications interface 1370. The received code may be executed by processor 1302 as it is received, or may be stored in memory 1304 or in storage device 1308 or any other non-volatile storage for later execution, or both. In this manner, computer system 1300 may obtain application program code in the form of signals on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

FIG. 14 illustrates a chip set or chip 1400 upon which an embodiment of the invention may be implemented. Chip set 1400 is programmed to provide points to at least one registered user for acquisition of a registered service, wherein payment may be partially made through automated redemption of the points from at least one point account as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1400 can be implemented in a single chip. It is further contemplated that in certain embodiments the chip set or chip 1400 can be implemented as a single “system on a chip.” It is further contemplated that in certain embodiments a separate ASIC would not be used, for example, and that all relevant functions as disclosed herein would be performed by a processor or processors. Chip set or chip 1400, or a portion thereof, constitutes a means for performing one or more steps of providing user interface navigation information associated with the availability of functions. Chip set or chip 1400, or a portion thereof, constitutes a means for performing one or more steps of providing points to at least one registered user for acquisition of a registered service, wherein payment may be partially made through automated redemption of the points from at least one point account.

In one embodiment, the chip set or chip 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1400 includes merely one or more processors and some software and/or firmware supporting and/or relating to and/or for the one or more processors.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to provide points to at least one registered user for acquisition of a registered service, wherein payment may be partially made through automated redemption of the points from at least one point account. The memory 1405 also stores the data associated with or generated by the execution of the inventive steps.

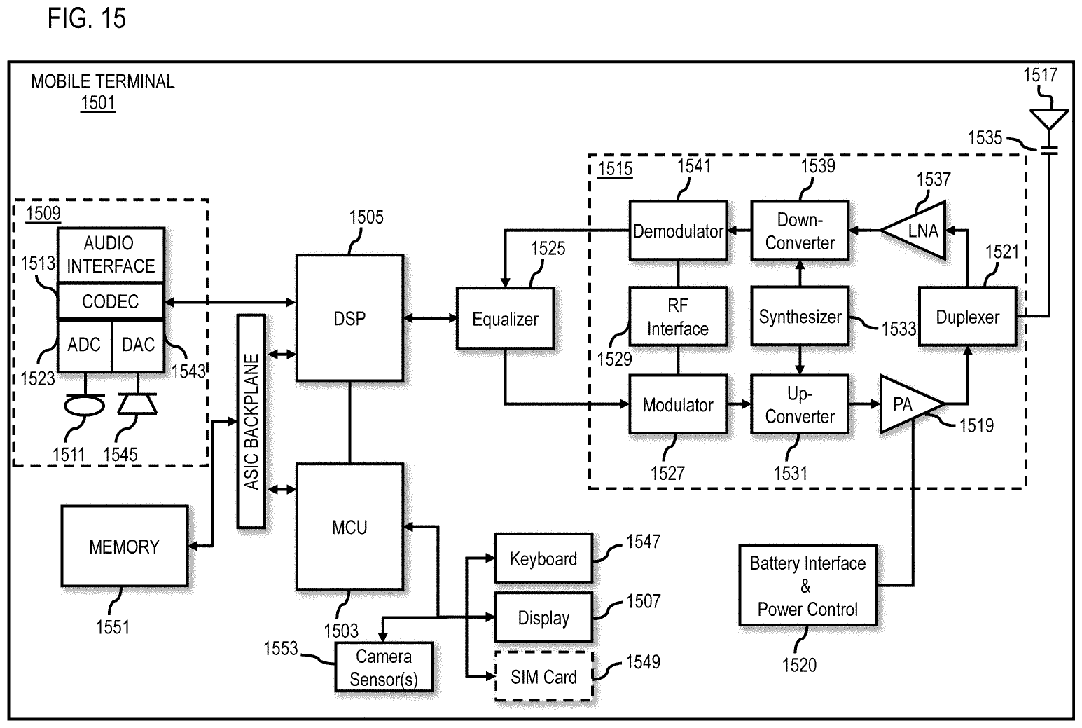

FIG. 15 is a diagram of exemplary components of a mobile terminal (e.g., handset) for communications, which is capable of operating in the system of FIG. 1, according to one embodiment. In some embodiments, mobile terminal 1501, or a portion thereof, constitutes a means for performing one or more steps of providing points to at least one registered user for acquisition of a registered service, wherein payment may be partially made through automated redemption of the points from at least one point account. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile terminal functions that perform or support the steps of providing points to at least one registered user for acquisition of a registered service, wherein payment may be partially made through automated redemption of the points from at least one point account. The display 1507 includes display circuitry configured to display at least a portion of a user interface of the mobile terminal (e.g., mobile telephone). Additionally, the display 1507 and display circuitry are configured to facilitate user control of at least some functions of the mobile terminal. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile terminal 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503 which can be implemented as a Central Processing Unit (CPU).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile terminal 1501 to provide points to at least one registered user for acquisition of a registered service, wherein payment may be partially made through automated redemption of the points from at least one point account. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the terminal. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile terminal 1501.

The CODEC 1513 includes the ADC 1523 and DAC 1543. The memory 1551 stores various data including call incoming tone data and is capable of storing other data including music data received via, e.g., the global Internet. The software module could reside in RANI memory, flash memory, registers, or any other form of writable storage medium known in the art. The memory device 1551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1549 carries, for instance, important information, such as the cellular phone number, the carrier supplying service, subscription details, and security information. The SIM card 1549 serves primarily to identify the mobile terminal 1501 on a radio network. The card 1549 also contains a memory for storing a personal telephone number registry, text messages, and user specific mobile terminal settings.

Further, one or more camera sensors 1553 may be incorporated onto the mobile station 1501 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A system comprising:
a first system configured to implement one or more first points at a first schema, wherein the one or more first points are provided based on a determined usage of a first service associated with the first system;
a second system configured to implement one or more second points at a second schema, wherein the one or more second points are provided based on a determined usage of a second service associated with the second system; and
an electronic interface configured to:
receive a request from a user device to apply one or more user points from the first system or the first service to the second system or the second service;
transform the one or more user points from the first schema to a fixed schema and then from the fixed schema to the second schema; and
transmit the one or more user points transformed at the second schema via the electronic interface to the second system.

2. The system of claim 1, further comprising:
retrieving a contract between (1) the first system or the first service and (2) the second system or the second service from a blockchain,
wherein the one or more user points are transformed based on the contract retrieved from the blockchain.

3. The system of claim 1, further comprising:
generating a data record indicating a redemption of the one or more transformed user points; and
transmitting the data record to the first system, the first service, the second system, the second service, or a combination thereof.

4. The system of claim 1, further comprising:
monitoring, in real-time, a change in convertibility between the one or more first points at the first schema and the one or more second points at the second schema; and
recommending at least one registered user of the user device to apply the one or more user points from the first system or the first service to the second system or the second service based on the change in convertibility.

5. The system of claim 1, further comprising:
processing activity information, contextual information, or a combination thereof associated with the at least one registered user of the user device to predict a next service for the at least one registered user; and
generating a presentation of the next service, one or more points associated with the next service, or a combination thereof in a user interface of the device.

6. The system of claim 5, further comprising:
receiving a request via a user interface element of the user device for the next service, wherein the first system implements the one or more points associated with the next service at a first schema upon determined usage of the next service; and
transferring automatically and in real-time the one or more user points from the first schema to a fixed schema and then from the fixed schema to the second schema.

7. The system of claim 1, wherein transforming the one or more user points further comprising:
determining the one or more user points from the first schema is sufficient for at least a portion of the one or more second points at a second schema.

8. The system of claim 1, further comprising:
updating, in real-time, the one or more user points in the first system, the second system, or a combination thereof, wherein the one or more first points in the first system is reduced and the one or more second points in the second system is increased based upon the transmitted one or more user points to the second system; and
presenting the updated one or more user points in a user interface of the device.

9. The system of claim 2, wherein the blockchain is configured to propagate one or more branching blockchains, and wherein the branching blockchains is configured to propagate one or more additional branching blockchains.

10. A method comprising:
providing an electronic interface between a first system with one or more points implemented at a first schema and a second system with one or more other points implemented at a second schema, wherein the one or more points are provided based on a determined usage of a first service associated with the first system, and wherein the one or more other points are provided based on a determined usage of a second service associated with the second system;
receiving a request from a user device to apply one or more user points from the first system or the first service to the second system or the second service;
transforming the one or more user points from the first schema to a fixed schema and then from the fixed schema to the second schema; and
transmitting the one or more transformed user points via the electronic interface to the second system.

11. The method of claim 10, further comprising:
retrieving a contract between (1) the first system or the first service and (2) the second system or the second service from a blockchain,
wherein the one or more user points are transformed based on the contract retrieved from the blockchain.

12. The method of claim 10, further comprising:
generating a data record indicating a redemption of the one or more transformed user points; and
transmitting the data record to the first system, the first service, the second system, the second service, or a combination thereof.

13. The method of claim 10, further comprising:
monitoring, in real-time, a change in convertibility between the one or more first points at the first schema and the one or more second points at the second schema; and
recommending at least one registered user of the user device to apply the one or more user points from the first system or the first service to the second system or the second service based on the change in convertibility.

14. The method of claim 10, further comprising:
processing activity information, contextual information, or a combination thereof associated with at the least one registered user of the user device to predict a next service for the at least one registered user; and
generating a presentation of the next service, one or more points associated with the next service, or a combination thereof in a user interface of the device.

15. The method of claim 14, further comprising:
receiving a request via a user interface element of the user device for the next service, wherein the first system implements the one or more points associated with the next service at a first schema upon determined usage of the next service; and
transferring automatically and in real-time the one or more user points from the first schema to a fixed schema and then from the fixed schema to the second schema.

16. The method of claim 10, wherein transforming the one or more user points further comprising:
determining the one or more user points from the first schema is sufficient for at least a portion of the one or more second points at a second schema.

17. The method of claim 10, further comprising:
updating, in real-time, the one or more user points in the first system, the second system, or a combination thereof, wherein the one or more first points in the first system is reduced and the one or more second points in the second system is increased based upon the transmitted one or more user points to the second system; and
presenting the updated one or more user points in a user interface of the device.

18. A non-transitory computer-readable storage medium carrying one or more sequences of one or more instructions which, when executed by one or more processors, cause an apparatus to at least perform the following steps:
providing an electronic interface between a first system with one or more points implemented at a first schema and a second system with one or more other points implemented at a second schema, wherein the one or more points are provided based on a determined or a first service associated with the first system, and wherein the one or more other points are provided based on a determined usage of a second service associated with the second system;
receiving a request from a user device to apply one or more user points from the first system or the first service to the second system or the second service;
transforming the one or more user points from the first schema to a fixed schema and then from the fixed schema to the second schema; and
transmitting the one or more transformed user points via the electronic interface to the second system.

19. The non-transitory computer-readable storage medium of claim 18, further comprising:
retrieving a contract between (1) the first system or the first service and (2) the second system or the second service from a blockchain,
wherein the one or more user points are transformed based on the contract retrieved from the blockchain.

20. The non-transitory computer-readable storage medium of claim 18, further comprising:
generating a data record indicating a redemption of the one or more transformed user points; and
transmitting the data record to the first system, the first service, the second system, the second service, or a combination thereof.
